(19) United States
(12) Patent Application Publication
(10) Pub. No.: US 2022/0248678 A1
(43) Pub. Date: Aug. 11, 2022

(54) HERBICIDAL COMPOUNDS

(71) Applicant: SYNGENTA CROP PROTECTION AG, Basel (CH)

(72) Inventors: Nigel James WILLETTS, Bracknell, Berkshire (GB); James Nicholas SCUTT, Bracknell, Berkshire (GB)

(73) Assignee: SYNGENTA CROP PROTECTION AG, Basel (CH)

(21) Appl. No.: 17/594,360

(22) PCT Filed: Apr. 9, 2020
(86) PCT No.: PCT/EP2020/060275

§ 371 Date: Oct. 13, 2021

(30) Foreign Application Priority Data
Apr. 16, 2019 (GB) 1905344.6

(51) Int. Cl. A01N 57/24; C07F 9/6509; A01P 13/00

(52) U.S. Cl. CPC A01N 57/24; A01P 13/00; C07F 9/650947

(57) ABSTRACT

The present invention relates to herbicidally active cinnolinium derivatives and formulations comprising such derivatives. The invention further extends to herbicidal mixtures comprising a cinnolinium derivative as described herein and at least one additional herbicidal active ingredient. The use of the afore-mentioned cinnolinium derivatives, formulations and/or herbicidal mixtures in controlling undesirable plant growth: in particular the use for the post-emergence control of weeds, also falls within the scope of the present invention.

The present invention relates to herbicidally active cinnolinium derivatives and formulations comprising such derivatives. The invention further extends to herbicidal mixtures comprising a cinnolinium derivative as described herein and at least one additional herbicidal active ingredient. The use of the afore-mentioned cinnolinium derivatives, formulations and/or herbicidal mixtures in controlling undesirable plant growth: in particular the use for the post-emergence control of weeds, also falls within the scope of the present invention.

Certain cinnolinium derivatives are known from U.S. Pat. No. 4,666,499 where they are stated to be useful for controlling unwanted plants.

The present invention is based on the finding that the incorporation of certain anionic surfactants in liquid formulations of such compounds, results in particularly efficient weed control. Furthermore the invention also provides novel cinnolinium derivatives per se, for use as herbicides.

Thus in a first aspect the invention provides a liquid agrochemical composition comprising:

(i) a herbicidally effective amount of a compound of Formula (I) or an agrochemically acceptable salt or zwitterionic species thereof:

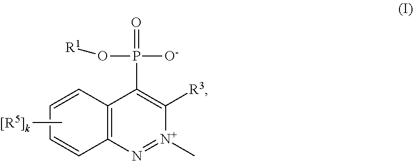

wherein R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁵, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶; R³ is selected from the group consisting of hydrogen, halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C1-C6alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or
R¹⁶ and R¹⁷ together with the nitrogen atom to which they are attached form a 4- to 6-membered heterocyclyl ring which optionally comprises one additional heteroatom individually selected from N, O and S;
(ii) at least one anionic surfactant that is an alkyl ether sulfate of Formula

R(OCH₂CH₂)ₙOSO₃⁻,

wherein R is a C₁₀-C₁₆alkyl group, and n is an integer of 2-30; and
(iii) at least one solvent.

Such an agricultural composition may further comprise at least one additional active ingredient.

Certain compounds of Formula (I) are novel, for example those where R³ is other than hydrogen, and also those where and those wherein R¹ is other than C₁-C₆alkyl. Compounds of Formula (IC) as defined herein also form a novel subset of compounds of Formula (I).

Thus, in a second aspect of the invention there is provided a compound of Formula (IA)

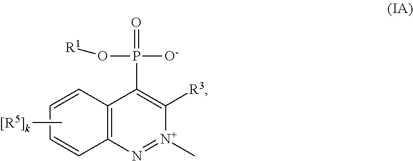

wherein, R¹ is selected from the group consisting of: C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶; R³ is selected from the group consisting of hydrogen, halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁶, —NR⁶S(O)₂R¹⁵, —C(O)OR¹⁵, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;

R¹⁰ is selected from the group consisting of hydrogen, C₁-C₆alkyl, phenyl and benzyl, and wherein said phenyl or benzyl are optionally substituted by 1, 2 or 3 R¹¹ substituents;

each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or
R¹⁶ and R¹⁷ together with the nitrogen atom to which they are attached form a 4- to 6-membered heterocyclyl ring which optionally comprises one additional heteroatom individually selected from N, O and S.

In a third aspect of the invention there is provided a compound of Formula (IB)

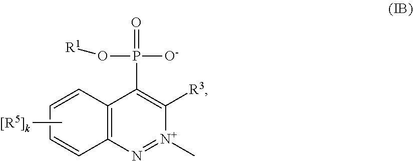

wherein

R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C1-C6alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or
R¹⁶ and R¹⁷ together with the nitrogen atom to which they are attached form a 4- to 6-membered heterocyclyl ring which optionally comprises one additional heteroatom individually selected from N, O and S.

In a fourth aspect of the invention there is provided a compound of Formula (IC)

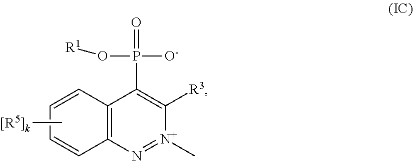

wherein R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or
R¹⁶ and R¹⁷ together with the nitrogen atom to which they are attached form a 4- to 6-membered heterocyclyl ring which optionally comprises one additional heteroatom individually selected from N, O and S;
with the proviso that
(i) when R³ is hydrogen, and k is 0, R¹ is not methyl, ethyl, isopropyl, n-butyl, 2, 2,2 trichloroethyl, or cylcohexyl;
(ii) when R³ is hydrogen, k is 1, and R⁵ is 5-chloro, 5-methyl, 5-methoxy, 6-chloro, 6-fluoro, 6-trifluoromethyl, 6-cyano, 6-nitro, 6-methoxy, 6-ethoxy, 6-isopropoxy, 6-methylsulfonyl, 6-methylthio, 7-trifluoromethyl, 7-methoxy, 7-nitro, 8-fluoro, 8-chloro, 8-trifluoromethyl, 8-nitro, 8-methoxy, 8-ethoxy, 8-isopropoxy, 8-methylsulfonyl, or 8-methylthio, then R¹ is not methyl; and
(iii) when R¹ is methyl, R³ is hydrogen, k is 2 and the two R⁵ substituents are either at positions 6 and 7, or positions 7 and 8 of the cinnolinium ring, then the two R⁵ substituents are not both methyl.

In a fifth aspect of the invention, there is provided the use of a compound of Formula (IA) or of Formula (IB) or of Formula (IC) as a herbicide.

In a sixth aspect of the invention, there is provided a method of controlling or preventing undesirable plant growth, wherein a herbicidally effective amount of a compound of Formula (IA) or Formula (IB) or Formula (IC) as active ingredient, or a liquid agrochemical composition of the invention, is applied to the plants, to parts thereof or the locus thereof.

Compounds of Formula (I), and in particular compounds of Formula (IA), Formula (IB), and Formula (IC) can be used as herbicidal agents in unmodified form, however, the present invention is based primarily on the finding that liquid herbicidal formulations of these compounds comprising a specific class of anionic surfactant are particularly efficacious. The liquid herbicidal compositions of the invention comprise at least three components: (i) a compound of Formula (I) as described herein; ii) at least one anionic surfactant that is an alkyl ether sulfate of Formula R(OCH₂CH₂)ₙOSO₃⁻, wherein R is a C₁₀-C₁₆alkyl group, and n is an integer of 2-30; and (iii) at least one solvent.

Anionic alkyl ether sulfate surfactants of the specified formula are readily available from a variety of commercial sources. They may be in ammonium or sodium salt form. When in the form of a sodium salt, they are commonly referred to as sodium laureth sulfate (or SLES), sodium pareth sulfate, or sodium myreth sulfate. Whilst the term laureth is traditionally used to define a C₁₂-C₁₄ alkyl chain length, the surfactants supplied are generally a mixture of alkyl chain lengths from C₁₀ to C₁₆ alkylene units, with the majority being in the C₁₂-C₁₄alkylene unit range. The degree of ethoxylation is given by the integer n, which refers to the average number of moles of EO per mole of fatty alcohol. Commercially available SLES and sodium pareth sulfate surfactants typically have a range of degrees of ethoxylation value of n between 2 and 4, but may have more, such as 6, 8, 10, 12 and the like. See Table 1 below for a non-exhaustive selection of commercially available suitable anionic alkyl ether sulfate surfactants:

TABLE 1
Anionic surfactants for use in the invention

| Alkyl chain | Degree of | | | | |
|---|---|---|---|---|---|
| length (R) | ethoxylation (n) | | | | |
| (average or | (average or | | | | |
| range) | range) | Salt | Tradename | Supplier | CAS number |
| C₁₂—C₁₄ | 3 | Sodium | EMPICOL ® | Huntsman | 3088-31-13 |
| | | | ESC 70 | | |
| C₁₂—C₁₄ | 2-4 | Ammonium | EMPICOL ® | Huntsman | 32612-48-9, |
| | | | EAC 70 | | 67762-19-0 |
| C₁₂—C₁₄ | 4 | Sodium | Spolonil AES | ENASPOL | 68585-34-2 |
| | | | 4859 | | |
| C₁₂—C₁₄ | 12 | Sodium | Spolonil AES 63 | ENASPOL | 68891-38-3 |
| C₁₂—C₁₄ | 3.5 | Sodium | Hansanol NS | ENASPOL | 68891-38-3 |
| | | | 243.5NC conc | | |
| C₁₂—C₁₄ | 3 | Ammonium | Spolapon AES | ENASPOL | 32612-48-9 |
| | | | 243 AM | | |
| C₁₂—C₁₅ | 3 | Sodium | Spolapon AES | ENASPOL | 91648-56-5 |
| | | | 253/Hansanol | | |
| | | | NS253 | | |

Preferably alkyl chain length (i.e, R) is Cu-Cis, more preferably C₁₂-C₁₄ Preferably the average degree of ethoxylation (i.e. n) is in the range 2-15 inclusive, more preferably in the range of 2-12, more preferably still in the range 2-4.

The formulations can be prepared e.g. by mixing the active ingredient with the anionic surfactant of component (ii) and the solvent of component (iii) in order to obtain compositions in the form of liquid concentrates, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art.

Additional formulation components that are suitable for incorporation in the compositions according to the invention are known per se. As liquid carriers/solvents there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydro-furfuryl alcohol, hexanol, octanol, ethylene glycol, propylene glycol, glycerol, N-methyl-2-pyrrolidone and the like.

Solid carriers for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances, may also be incorporated in the compositions of the invention.

Additional surface-active substances may be used in compostions of the invention, in particular in those formulations which can be diluted with a carrier prior to use. Such additional surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood N.J. (1981).

Further adjuvants that may be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention may include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The liquid compositions of the invention can be in various physical forms, e.g. in the form of gels, emulsifiable concentrates, microemulsifiable concentrates, oil-in-water emulsions, oil-flowables, aqueous dispersions, oily dispersions, suspo-emulsions, capsule suspensions, soluble liquids, water-soluble concentrates (with water or a water-miscible organic solvent as carrier), or in other liquid forms known e.g. from the Manual on Development and Use of FAO and WHO Specifications for Pesticides, United Nations, First Edition, Second Revision (2010). Thus in one embodiment, the liquid agrochemical composition of the invention is an emulsion concentrate (EC), and emulsion in water (EW), a microcapsule formulation (CS), a dispersion concentrate (DC), a suspension of particles in an emulsion (SE), a suspension of particles in oil (OD), or a soluble liquid (SL). Such formulations can either be used directly or diluted prior to use. The dilutions can be made, for example, with water, liquid fertilisers, micronutrients, biological organisms, oil or solvents.

As stated above, the liquid herbicidal compositions of the invention comprise a compound of Formula (I)

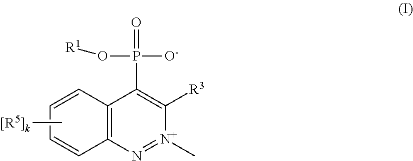

wherein the substituents R¹, R³, R⁵ and k are as specified herein. Further details with respect to the various substituents and the terminology employed are given below.

As used herein, the term “halogen” or “halo” refers to fluorine (fluoro), chlorine (chloro), bromine (bromo) or iodine (iodo), preferably fluorine, chlorine or bromine.

As used herein, cyano means a —CN group.

As used herein, hydroxy means an —OH group.

As used herein, amino means an —NH₂ group.

As used herein, nitro means an —NO₂ group.

As used herein, the term “C₁-C₆alkyl” refers to a straight or branched hydrocarbon chain radical consisting solely of carbon and hydrogen atoms, containing no unsaturation, having from one to six carbon atoms, and which is attached to the rest of the molecule by a single bond. C₁-C₄alkyl and C₁-C₂alkyl are to be construed accordingly. Examples of C₁-C₆alkyl include, but are not limited to, methyl (Me), ethyl (Et), n-propyl, 1-methylethyl (iso-propyl), n-butyl, and 1-dimethylethyl (t-butyl).

As used herein, the term “C₁-C₆alkoxy” refers to a radical of the formula —ORₐ where Rₐ is a C₁-C₆alkyl radical as generally defined above. C₁-C₄alkoxy is to be construed accordingly. Examples of C₁₋₄alkoxy include, but are not limited to, methoxy, ethoxy, propoxy, iso-propoxy and t-butoxy.

As used herein, the term “C₁-C₆haloalkyl” refers to a C₁-C₆alkyl radical as generally defined above substituted by one or more of the same or different halogen atoms. C₁-C₄haloalkyl is to be construed accordingly. Examples of C₁-C₆haloalkyl include, but are not limited to chloromethyl, fluoromethyl, fluoroethyl, difluoromethyl, trifluoromethyl and 2,2,2-trifluoroethyl.

As used herein, the term “C₂-C₆alkenyl” refers to a straight or branched hydrocarbon chain radical group consisting solely of carbon and hydrogen atoms, containing at least one double bond that can be of either the (E)- or (Z)-configuration, having from two to six carbon atoms, which is attached to the rest of the molecule by a single bond. C₂-C₄alkenyl is to be construed accordingly. Examples of C₂-C₆alkenyl include, but are not limited to, prop-1-enyl, allyl (prop-2-enyl) and but-1-enyl.

As used herein, the term “C₂-C₆haloalkenyl” refers to a C₂-C₆alkenyl radical as generally defined above substituted by one or more of the same or different halogen atoms. Examples of C₂-C₆haloalkenyl include, but are not limited to chloroethylene, fluoroethylene, 1,1-difluoroethylene, 1,1-dichloroethylene and 1,1,2-trichloroethylene.

As used herein, the term “C₂-C₆alkynyl” refers to a straight or branched hydrocarbon chain radical group consisting solely of carbon and hydrogen atoms, containing at least one triple bond, having from two to six carbon atoms, and which is attached to the rest of the molecule by a single bond. C₂-C₄alkynyl is to be construed accordingly. Examples of C₂-C₆alkynyl include, but are not limited to, prop-1-ynyl, propargyl (prop-2-ynyl) and but-1-ynyl.

As used herein, the term “C₁-C₆haloalkoxy” refers to a C₁-C₆alkoxy group as defined above substituted by one or more of the same or different halogen atoms. C₁-C₄haloalkoxy is to be construed accordingly. Examples of C₁-C₆haloalkoxy include, but are not limited to, fluoromethoxy, difluoromethoxy, fluoroethoxy, trifluoromethoxy and trifluoroethoxy.

As used herein, the term “C₁-C₆haloalkoxyC₁-C₆alkyl” refers to a radical of the formula R_{b}—O—Rₐ— where R_{b} is a C₁-C₆haloalkyl radical as generally defined above, and Rₐ is a C₁-C₆alkylene radical as generally defined above.

As used herein, the term “C₁-C₆alkoxyC₁-C₆alkyl” refers to a radical of the formula R_{b}—O—Rₐ— where R_{b} is a C₁-C₆alkyl radical as generally defined above, and Rₐ is a C₁-C₆alkylene radical as generally defined above.

As used herein, the term “C₃-C₆alkenyloxy” refers to a radical of the formula —ORₐ where Rₐ is a C₃-C₆alkenyl radical as generally defined above.

As used herein, the term “C₃-C₆alkynyloxy” refers to a radical of the formula —ORₐ where Rₐ is a C₃-C₆alkynyl radical as generally defined above.

As used herein, the term “hydroxyC₁-C₆alkyl” refers to a C₁-C₆alkyl radical as generally defined above substituted by one or more hydroxy groups.

As used herein, the term “C₃-C₆cycloalkyl” refers to a stable, monocyclic ring radical which is saturated or partially unsaturated and contains 3 to 6 carbon atoms. C₃-C₄cycloalkyl is to be construed accordingly. Examples of C₃-C₆cycloalkyl include, but are not limited to, cyclopropyl, cyclobutyl, cyclopentyl and cyclohexyl. The term “C₁-C₃alkylC₃-C₆cycloalkyl” thus refers to a radical of formula —Rₐ—C₃-C₆cylocalkyl, where Rₐ is a C₁-C₃ alkylene radical as described above.

As used herein, the term “C₃-C₆halocycloalkyl” refers to a C₃-C₆cycloalkyl radical as generally defined above substituted by one or more of the same or different halogen atoms. C₃-C₄halocycloalkyl is to be construed accordingly.

As used herein, the term “C₃-C₆cycloalkoxy” refers to a radical of the formula —ORₐ where Rₐ is a C₃-C₆cycloalkyl radical as generally defined above.

As used herein, except where explicitly stated otherwise, the term “heteroaryl” refers to a 5- or 6-membered monocyclic aromatic ring which comprises 1, 2, 3 or 4 heteroatoms individually selected from nitrogen, oxygen and sulfur. The heteroaryl radical may be bonded to the rest of the molecule via a carbon atom or heteroatom. Examples of heteroaryl include, furyl, pyrrolyl, imidazolyl, thienyl, pyrazolyl, thiazolyl, isothiazolyl, oxazolyl, isoxazolyl, triazolyl, tetrazolyl, pyrazinyl, pyridazinyl, pyrimidyl or pyridyl.

As used herein, except where explicitly stated otherwise, the term “heterocyclyl” or “heterocyclic” refers to a stable 3- to 6-membered non-aromatic monocyclic ring radical which comprises 1, 2, or 3 heteroatoms individually selected from nitrogen, oxygen and sulfur. The heterocyclyl radical may be bonded to the rest of the molecule via a carbon atom or heteroatom. Examples of heterocyclyl include, but are not limited to, pyrrolinyl, pyrrolidyl, tetrahydrofuryl, tetrahydrothienyl, tetrahydrothiopyranyl, piperidyl, piperazinyl, tetrahydropyranyl, dihydroisoxazolyl, dioxolanyl, morpholinyl or δ-lactamyl.

The presence of one or more possible asymmetric carbon atoms in a compound of Formula (I) means that the compounds may occur in chiral isomeric forms, i.e., enantiomeric or diastereomeric forms. Also atropisomers may occur as a result of restricted rotation about a single bond. Formula (I) is intended to include all those possible isomeric forms and mixtures thereof. The present invention includes all those possible isomeric forms and mixtures thereof for a compound of Formula (I). Likewise, Formula (I) is intended to include all possible tautomers (including lactam-lactim tautomerism and keto-enol tautomerism) where present. The present invention includes all possible tautomeric forms for a compound of Formula (I). Similarly, where there are di-substituted alkenes, these may be present in E or Z form or as mixtures of both in any proportion. The present invention includes all these possible isomeric forms and mixtures thereof for a compound of Formula (I).

The compounds of Formula (I) will typically be provided in the form of an agronomically acceptable salt, a zwitterion or an agronomically acceptable salt of a zwitterion. This invention covers all such agronomically acceptable salts, zwitterions and mixtures thereof in all proportions.

For example a compound of Formula (I) wherein the moiety at the 4-position of the cinolinium ring bears an acidic proton, may exist as a zwitterion, e.g as a compound of Formula (I-I)), or as an agronomically acceptable salt, e.g. as a compound of Formula (I-II) as shown below:

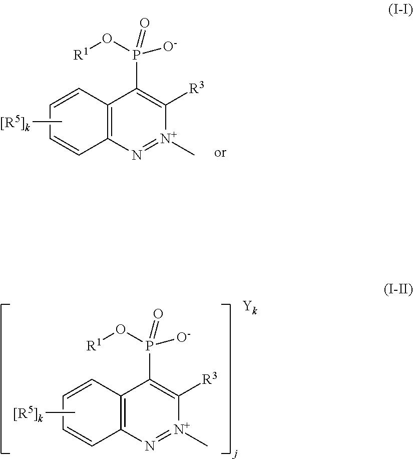

wherein, Y represents an agronomically acceptable anion and j and k represent integers that may be selected from 1, 2 or 3, dependent upon the charge of the respective anion Y.

A compound of Formula (I) may also exist as an agronomically acceptable salt of a zwitterion in the form of a compound of formula (I-IV) as shown below:

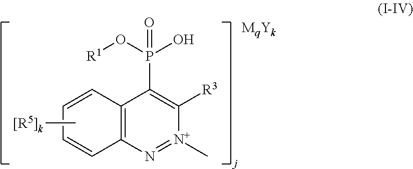

wherein, Y represents an agronomically acceptable anion, M represents an agronomically acceptable cation (in addition to the cinnolinium cation) and the integers j, k and q may be selected from 1, 2 or 3, dependent upon the charge of the respective anion Y and respective cation M.

Thus where a compound of Formula (I) is drawn in protonated form herein, the skilled person would appreciate that it could equally be represented in unprotonated or salt form with one or more relevant counter ions.

In one embodiment of the invention there is provided a compound of formula (I-II) or formula (I-IV) wherein k is 2, j is 1 and Y is selected from the group consisting of halogen, trifluoroacetate and pentafluoropropionate. In this embodiment a nitrogen atom comprised in R¹, R², R³, R⁴, R⁵ may be protonated.

Suitable agronomically acceptable salts of the present invention, represented by an anion Y, include but are not limited chloride, bromide, iodide, fluoride, 2-naphthalenesulfonate, acetate, adipate, methoxide, ethoxide, propoxide, butoxide, aspartate, benzenesulfonate, benzoate, bicarbonate, bisulfate, bitartrate, butylsulfate, butylsulfonate, butyrate, camphorate, camsylate, caprate, caproate, caprylate, carbonate, citrate, diphosphate, edetate, edisylate, enanthate, ethanedisulfonate, ethanesulfonate, ethylsulfate, formate, fumarate, gluceptate, gluconate, glucoronate, glutamate, glycerophosphate, heptadecanoate, hexadecanoate, hydrogen sulfate, hydroxide, hydroxynaphthoate, isethionate, lactate, lactobionate, laurate, malate, maleate, mandelate, mesylate, methanedisulfonate, methylsulfate, mucate, myristate, napsylate, nitrate, nonadecanoate, octadecanoate, oxalate, pelargonate, pentadecanoate, pentafluoropropionate, perchlorate, phosphate, propionate, propylsulfate, propylsulfonate, succinate, sulfate, tartrate, tosylate, tridecylate, triflate, trifluoroacetate, undecylinate and valerate.

Suitable cations represented by M include, but are not limited to, metals, conjugate acids of amines and organic cations. Examples of suitable metals include aluminium, calcium, cesium, copper, lithium, magnesium, manganese, potassium, sodium, iron and zinc. Examples of suitable amines include allylamine, ammonia, amylamine, arginine, benethamine, benzathine, butenyl-2-amine, butylamine, butylethanolamine, cyclohexylamine, decylamine, diamylamine, dibutylamine, diethanolamine, diethylamine, diethylenetriamine, diheptylamine, dihexylamine, diisoamylamine, diisopropylamine, dimethylamine, dioctylamine, dipropanolamine, dipropargylamine, dipropylamine, dodecylamine, ethanolamine, ethylamine, ethylbutylamine, ethylenediamine, ethylheptylamine, ethyloctylamine, ethylpropanolamine, heptadecylamine, heptylamine, hexadecylamine, hexenyl-2-amine, hexylamine, hexylheptylamine, hexyloctylamine, histidine, indoline, isoamylamine, isobutanolamine, isobutylamine, isopropanolamine, isopropylamine, lysine, meglumine, methoxyethylamine, methylamine, methylbutylamine, methylethylamine, methylhexylamine, methylisopropylamine, methylnonylamine, methyloctadecylamine, methylpentadecylamine, morpholine, N,N-diethylethanolamine, N-methylpiperazine, nonylamine, octadecylamine, octylamine, oleylamine, pentadecylamine, pentenyl-2-amine, phenoxyethylamine, picoline, piperazine, piperidine, propanolamine, propylamine, propylenediamine, pyridine, pyrrolidine, sec-butylamine, stearylamine, tallowamine, tetradecylamine, tributylamine, tridecylamine, trimethylamine, triheptylamine, trihexylamine, triisobutylamine, triisodecylamine, triisopropylamine, trimethylamine, tripentylamine, tripropylamine, tris(hydroxymethyl)aminomethane, and undecylamine. Examples of suitable organic cations include benzyltributylammonium, benzyltrimethylammonium, benzyltriphenylphosphonium, choline, tetrabutylammonium, tetrabutylphosphonium, tetraethylammonium, tetraethylphosphonium, tetramethylammonium, tetramethylphosphonium, tetrapropylammonium, tetrapropylphosphonium, tributylsulfonium, tributylsulfoxonium, triethylsulfonium, triethylsulfoxonium, trimethylsulfonium, trimethylsulfoxonium, tripropylsulfonium and tripropylsulfoxonium.

Preferred compounds of Formula (I), for use in the invention can be represented as either (I-I), (I-II), or (I-IV). For compounds of formula (I-II) or (I-IV) emphasis is given to salts when Y is chloride, bromide, iodide, hydroxide, bicarbonate, acetate, pentafluoropropionate, perchlorate, triflate, trifluoroacetate, methylsulfate, tosylate and nitrate, wherein j and k are 1. Preferably, Y is chloride, bromide, iodide, hydroxide, bicarbonate, acetate, trifluoroacetate, methylsulfate, tosylate and nitrate, wherein j and k are 1. For compounds of formula (I-II) or (I-IV) emphasis is also given to salts when Y is carbonate and sulfate, wherein j is 2 and k is 1, and when Y is phosphate, wherein j is 3 and k is 1.

Where appropriate compounds of formula (I) may also be in the form of (and/or be used as) an N-oxide.

Preferred values of R¹, R², R³, R⁴, R⁵, R⁶, r and k in a compound of Formula (I) as employed in the invention are listed below. Compounds of Formula (I) may comprise any combination of said values. The skilled man will appreciate that values for any specified set of embodiments may combined with values for any other set of embodiments where such combinations are not mutually exclusive. Where appropriate, the preferences below also apply to compounds of Formula (IA) and Formula (IB), both of which represent novel sub-sets of compounds of Formula (I), by virtue of their restricted definitions for R¹ and R³ respectively.

Preferably R¹ is selected from the group consisting of C₁-C₄alkyl, C₂-C₄alkenyl, C₂-C₄alkynyl, C₃-C₆cycloalkyl, —C₁-C₃alkylC₃-C₆cycloalkyl, —C₁-C₃alkyl-C₅-C₆heterocyclyl, C₁-C₃alkoxy-C₁-C₃alkyl, C₁-C₃haloalkyl, phenyl, benzyl, furyl, pyrrolyl, imidazolyl, thienyl, pyrazolyl, thiazolyl, isothiazolyl, oxazolyl, isoxazolyl, triazolyl, tetrazolyl, pyrazinyl, pyridazinyl, pyrimidyl or pyridyl, pyrrolinyl, pyrrolidyl, tetrahydrofuryl, tetrahydrothienyl, tetrahydrothiopyranyl, piperidyl, piperazinyl, tetrahydropyranyl, dihydroisoxazolyl, dioxolanyl, morpholinyl and δ-lactamyl.

More preferably R¹ is selected from the group consisting of methyl, ethyl, n-propyl, iso-propyl, n-butyl, sec-butyl, tert-butyl or iso-butyl, allyl, propargyl, cylopropyl, cyclohexyl, methylcylopropyl, methylcyclohexyl, methyltetrahydrofuryl, C₁-C₂alkoxy-C₁-C₃alkyl, C₁-C₃haloalkyl, phenyl, and tetrahydrofuryl.

For compounds of Formula (IA), R¹ is preferably selected from the group consisting of C₂-C₄alkenyl, C₂-C₄alkynyl, C₃-C₅cycloalkyl, —C₁-C₃alkylC₃-C₆cycloalkyl, —C₁-C₃alkyl-C₅-C₆heterocyclyl, C₁-C₃alkoxy-C₁-C₃alkyl, C₁-C₃haloalkyl, phenyl, benzyl, furyl, pyrrolyl, imidazolyl, thienyl, pyrazolyl, thiazolyl, isothiazolyl, oxazolyl, isoxazolyl, triazolyl, tetrazolyl, pyrazinyl, pyridazinyl, pyrimidyl or pyridyl, pyrrolinyl, pyrrolidyl, tetrahydrofuryl, tetrahydrothienyl, tetrahydrothiopyranyl, piperidyl, piperazinyl, tetrahydropyranyl, dihydroisoxazolyl, dioxolanyl, morpholinyl and δ-lactamyl. For compounds of Formula (IA) R¹ is more preferably selected from the group consisting of allyl, propargyl, cylopropyl, methylcylopropyl, methylcyclohexyl, methyltetrahydrofuryl, C₁-C₂alkoxy-C₁-C₃alkyl, C₁-C₃haloalkyl, phenyl, and tetrahydrofuryl.

Preferably, for compounds of Formula (I) and Formula (IA), R³ is selected from the group consisting of hydrogen, halogen and C₁-C₆alkyl, phenyl and thiazole, wherein said phenyl or thiazole is optionally substituted by 1 or 2 R², which may be the same or different. More preferably for compounds of Formula (I) and Formula (IA), R³ is selected from the group consisting of hydrogen, C₁-C₃alkyl, thiazole and phenyl. Even more preferably for compounds of Formula (I) and Formula (IA), R³ is selected from the group consisting of hydrogen, methyl, thiazole and phenyl.

For compounds of Formula (IB) R³ is preferably selected from the group consisting of halogen and C₁-C₆alkyl, phenyl and thiazole, wherein said phenyl or thiazole is optionally substituted by 1 or 2 R², which may be the same or different. More preferably for compounds of Formula (IB), R³ is selected from the group consisting of C₁-C₃alkyl, thiazole and phenyl. Even more preferably for compounds of Formula (IB), R³ is selected from the group consisting of methyl, thiazole and phenyl.

As stated herein, the cinnolinium ring may be substituted at positions 5, 6, 7, or 8 by by k number of R⁵ groups. For the avoidance of doubt, when k is 0, R⁵ is absent, and the cinnolinium ring bears no substitution at position 5, 6, 7, or 8.

When k is 3 or 4, preferably each R⁵ is independently selected from the group consisting of chloro, fluoro, bromo, iodo, methoxy, methyl and trifluoromethyl.

When k is 1 or 2, each R⁵ is preferably independently selected from the group consisting of halogen, cyano, amino, di-C₁-C₃alkylamino, C₁-C₃alkyl, C₁-C₃fluoroalkyl, C₁-C₃fluoroalkoxy C₁-C₃alkoxy. More preferably when k is 1 or 2, each R⁵ is independently selected from the group consisting of chloro, fluoro, methoxy and methyl. Even more preferably when k is 1 or 2 each R⁵ is independently selected from the group consisting of methyl and methoxy. Most preferably when k is 1 or 2, each R⁵ is methyl.

As defined herein, k is 0, 1, 2, 3 or 4. Preferably k is 0, 1 or 2. More preferably k is 0 or 1. In one set of embodiments k is 1. In another set of embodiments k is 0.

The compounds in Tables 1 to 7 below illustrate the compounds of Formula (I)—including compounds of Formulae (IA), (IB) and (IC), for use in the invention. The skilled person will understand that the compounds of Formula (I) may exist as an agronomically acceptable salt, a zwitterion or an agronomically acceptable salt of a zwitterion as described above.

TABLE 1
This table discloses 10 specific compounds of the formula (T-1):

| | | (T-1) |
|---|---|---|
| 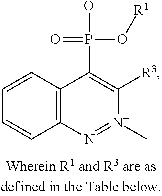 | | |
| Compound | | |
| number | R¹ | R³ |
| 1.001 | —CH₃ | —H |
| 1.002 | —CH₂CH₃ | —H |
| 1.003 | —CH₂CH₂CH₃ | —H |
| 1.004 | —CH(CH₃)₂ | —H |
| 1.005 | —CH₂CH₂CH₂CH₃ | —H |
| 1.006 | —CH₂CH═CH₂ | —H |
| 1.007 | —CH₂C≡CH | —H |
| 1.008 | —CH₂CF₃ | —H |
| 1.009 | —CH₂CH₂OCH₃ | —H |
| 1.010 | —CH₂cyclopropyl | —H |

TABLE 2
This table discloses 10 specific compounds - compounds
2.001-2.010 - of the formula (T-2):

| | |
|---|---|
| 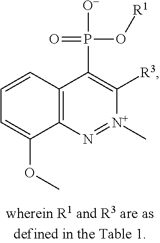 | (T-2) |

TABLE 3
This table discloses 10 specific compounds - compounds
3.001-3.010 - of the formula (T-3):

| | |
|---|---|
| 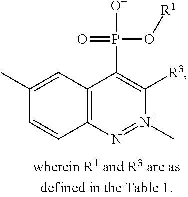 | (T-3) |

TABLE 4
This table discloses 10 specific compounds - compounds
4.001-4.010 - of the formula (T-4):

| | |
|---|---|
| 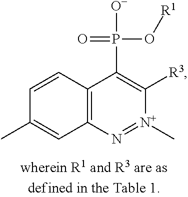 | (T-4) |

TABLE 5
This table discloses 10 specific compounds - compounds
5.001-5.010 - of the formula (T-5):

| | |
|---|---|
| 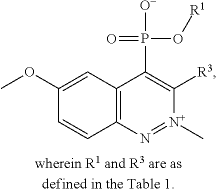 | (T-5) |

TABLE 6
This table discloses 10 specific compounds - compounds
6.001-6.010 - of the formula (T-6):

| | |
|---|---|
| 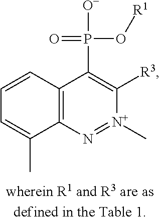 | (T-6) |

TABLE 7
This table discloses 10 specific compounds - compounds
7.001-73.010 - of the formula (T-7):

| | |
|---|---|
| 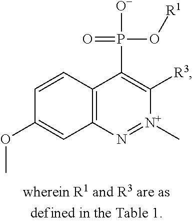 | (T-7) |

The compounds of Formula (I) may be prepared by heating a compound of formula (A), wherein R¹, R³, R⁵ and k are as defined above, in a suitable solvent at a suitable temperature, as described in reaction scheme 1. Related alkyl transfer reactions are known in the literature, see for example Ponte, J. R. et al, U.S. Pat. No. 4,666,499.

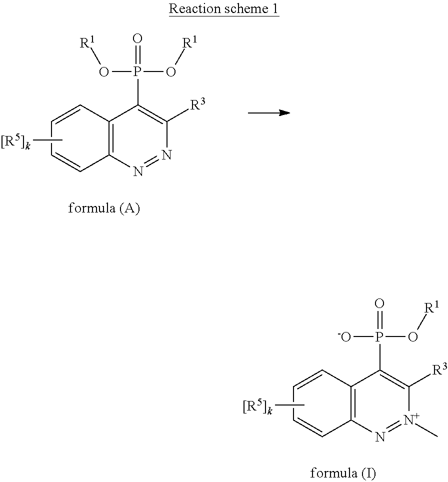

A compound of formula (A), wherein R¹, R³, R⁵ and k are as defined for compounds of Formula (I), may be prepared from a compound of formula (ZZ), wherein LG is a leaving group, for example, halide or pseudohalide, such as triflate, mesylate or tosylate, as described in reaction scheme 2. Example conditions include reacting a compound of formula (A) with a reagent of formula P(OR¹)₃ or HP(O)(OR¹)₂ in the presence of an appropriate transition metal catalyst, ligand and base, in an appropriate solvent and at an appropriate temperature. See, for example, Keglevich, G., Gruen, A., Boelcskei, A., Drahos, L., Kraszni, M., Balogh, G. T., Heteroatom Chemistry, 23(6), 2012, 574, Fang, C., Chen, Z., Liu, X., Yang, Y., Deng, M., Weng, L., Jia, Y., Zhou, Y., Inorganica Chimica Acta, 362(7), 2009, 2101 and Hynek, J., Brazda, P., Rohlicek, J., Londesborough, M. G. S., Demel, J., Angewandte Chemie, International Edition, 57(18), 2018, 5016.

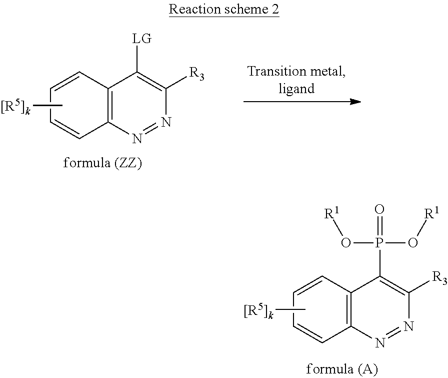

In an alternative approach a compound of formula (A) may be prepared by nucleophilic displacement on a compound of formula (ZZ), wherein LG includes, but is not limited to, halide or pseudohalide, such as triflate, mesylate or tosylate, or a compound of formula (Y), wherein R³, R⁴, R⁵ and k are as defined for compounds of Formula (I), as described in reaction scheme 3. Similar reactions are known in the literature, see for example Gardner, G.; Steffens, J. J.; Grayson, B. T.; Kleier, D. A. J. Agric. Food. Chem., 1992, 318-321, and Miyashita, A.; Suzuki, Y.; Iwamoto, K.; Oishi, E.; Higashino, T. Heterocycles, 1998, 49, 405). Compounds of formula (Y) are known in the literature, for example, Kleier, D. A. J. Agric. Food. Chem., 1992, 318-321, Barlin, G. B.; Brown, W. V. J. Chem. Soc (C), 1969, 921-923 and Klatt, T. et al Org. Lett. 2014, 16, 1232-1235.

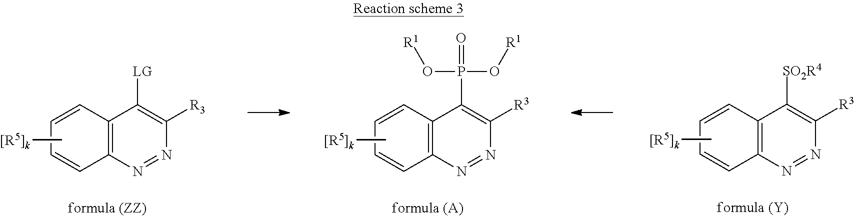

A compound of formula (ZZ), wherein R³, R⁵ and k are as defined for compounds of formula (I) and LG is a halide, may be prepared from a 4-hydroxycinnoline of formula (AZ) by treatment with known halogenating agents, such as a phosphoryl halide, in a suitable solvent at a suitable temperature, as described in reaction scheme 4. See, for example, Ruchelman, A. L. et al Bioorg. Med. Chem., 2004, 12(4), 795-806).

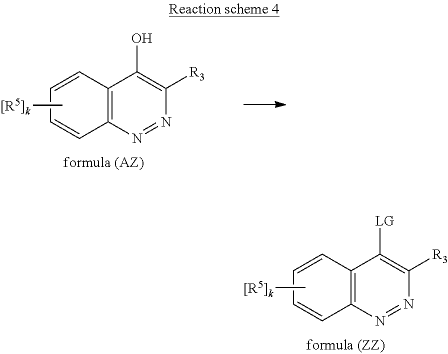

Hydroxycinnolines of formula (AZ), wherein R³, R⁵ and k are as defined for compounds of formula (I), may be prepared by the diazotisation of an optionally substituted 2-aminoarylketone of formula (L) with either an inorganic nitrite or alkyl nitrite in the presence of acid in a suitable solvent at a suitable temperature, see for example, Borsche, W.; Herbert, A. Liebigs Ann. Chem., 1941, 546, 293 and Koelsch, C. F. J. Org. Chem., 1943, 8, 295, as described in reaction scheme 5. Compounds of formula (L) are known in the literature or may be prepared by known methods, for example, Jana, S. et al Org. Biomol. Chem., 2015, 13(31), 8411-8415.

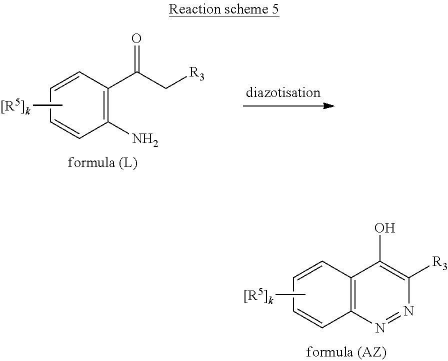

In an alternative approach a compound of formula (AZ) may be prepared by a sequence starting with the oxidation of a 2-haloacetophenone of formula (R), wherein R³, R⁵ and k are as defined for a compound of Formula (I) and Hal is a halide, using a suitable oxidizing agent in a suitable solvent at a suitable temperature, for example selenium dioxide in 1,4-dioxane at a temperature between 25° C. to 100° C. Compounds of formula (S), wherein R³, R⁵ and k are as defined for a compound of Formula (I), may be condensed with an optionally protected hydrazine of formula (AY), wherein PG is either hydrogen or a suitable protecting group, to afford a hydrazone of formula (T), wherein R³, R⁵ and k are as defined for a compound of Formula (I), preferably in the presence of an acid catalyst in a suitable solvent at a suitable temperature. An example of a hydrazine of formula (AY), but not limited to, is tert-butyl carbazate. Cyclisation of a compound of formula (T) to a compound of formula (AZ) may be achieved by treatment with a suitable base in a suitable solvent at a suitable temperature, for example potassium carbonate in N,N-dimethylformamide at a temperature between 25° C. and 150° C. This sequence of reactions is described in reaction scheme 6. Compounds of formula (R) are known in the literature or may be prepared by known methods, see, for example, Ruan, J. et al J. Am. Chem. Soc., 2010, 132(46), 16689-16699, 2010 and Ridge, D. N. et al J. Med. Chem., 1979, 22(11), 1385-1389.

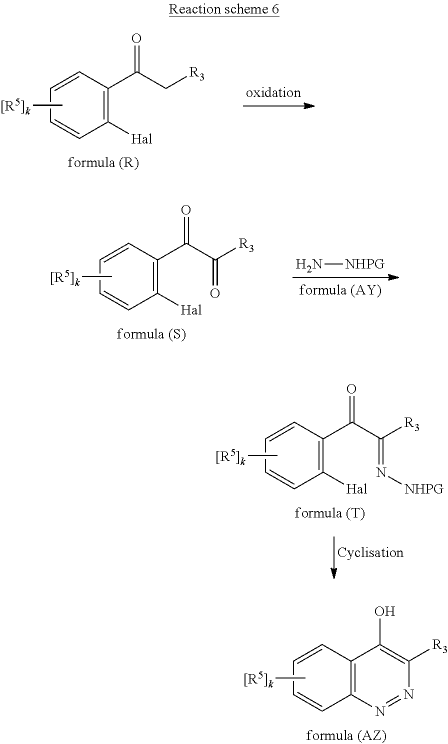

A compound of formula (A), wherein R¹, R³, R⁵ and k are as previously defined and the R¹ substituents are different, may be prepared by reacting a compound of formula (P) with an alcohol of formula (U), wherein R¹ is as defined for a compound of Formula (I) and is different to the R¹ in a compound of formula (P), in an appropriate solvent at an appropriate temperature, as outlined in reaction scheme 7. See, for example, Kiss, N. Z.; Henyecz, R; Jablonkai. E.; Keglevich, G., Synth. Commun., 2016, 46(9), 766.

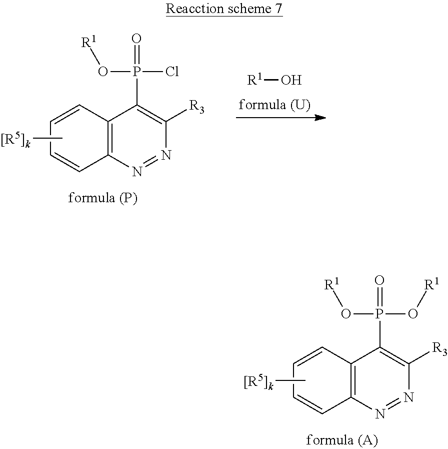

A compound of formula (P) may be prepared by treating a compound of formula (A), wherein R¹, R³, R⁵ and k are as previously defined, with an appropraite chlorinating agent, such as phosphorus pentachloride or oxalyl chloride, in an appropriate solvent at an appropriate temperature, as outlined in reaction scheme 8. See, for example, Goryunov, E. I., Baulina, T. V., Goryunova, I. B., Matveeva, A. G., Safiulina, A. M., Nifant'ev, E. E., Russian Chemical Bulletin, 63(1), 2014, 141.

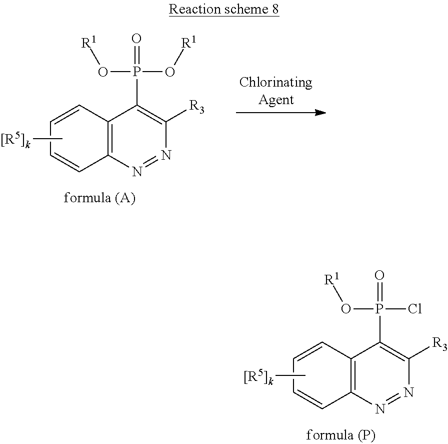

A compound of Formula (I) may also be prepared from a compound of formula (B), wherein R¹, R³, R⁵ and k are as defined for a compound of formula (I), through partial hydrolysis by treatment with a suitable reagent, for example, but not limited to, aqueous hydrochloric acid or trimethylsilyl bromide, in a suitable solvent at a suitable temperature between 0° C. and 100° C., as outlined in reaction scheme 9.

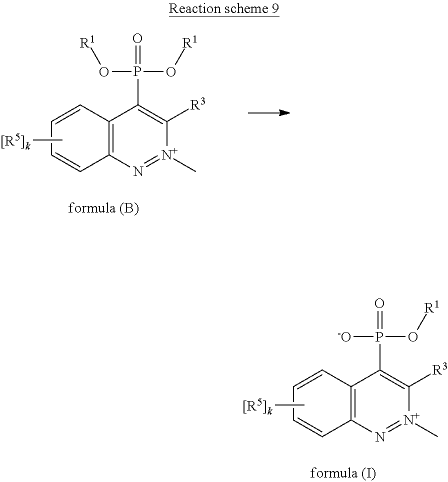

A compound of formula (B) may be prepared from a compound of formula (A), wherein R¹, R³, R⁵ and k are as defined previously, by reaction with a suitable methylating agent, optionally in the presence of a suitable solvent at a suitable temperature, as outlined in reaction scheme 10. Examples, but not limited to, of such methylating agents are methyl iodide and dimethylsulfate.

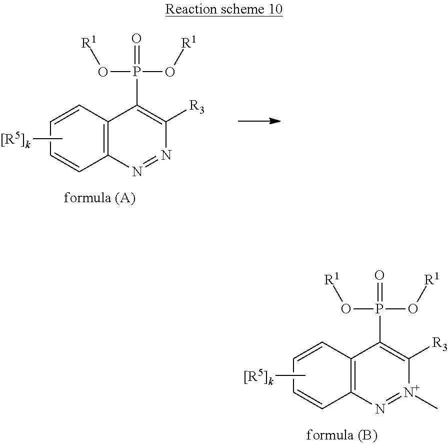

Furthermore, compounds of formula (B) may be prepared by reacting compounds of formula (A), wherein R¹, R³, R⁵ and k are as defined previously, with methanol under Mitsunobu-type conditions such as those reported by Petit et al, Tet. Lett. 2008, 49 (22), 3663. Suitable phosphines include triphenylphosphine, suitable azodicarboxylates include diisopropylazodicarboxylate and suitable acids include fluoroboric acid, triflic acid and bis(trifluoromethylsulfonyl)amine, as outlined in reaction scheme 11. Such alcohols are either known in the literature or may be prepared by known literature methods.

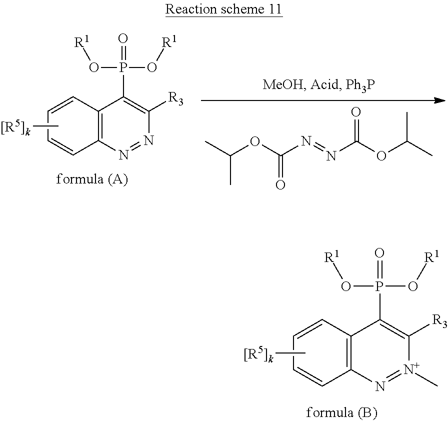

Liquid agrochemical compositions of the invention may be formulated as a concentrate, which is subsequently diluted—typically with water—by the end user for application. Alternatively, liquid agrochemical compositions of the invention may be in the form of a ready-to-use formulation. Thus, compositions of the invention may comprise anything from 0.05% w/v of a compound of Formula (I) to 50% w/v of a compound of Formula (I), depending on the nature of the formulation (i.e. concentrate, or ready-to-use). In particular a compound of Formula (I) may be employed at, for example, a concentration of 0.05%, 0.0625% 0.10%, 0.125%, 0.20%, 0.25%, 0.30%, 0.40%, 0.50%, 0.60%, 0.70%, 0.75%, 0.80%, 0.90%, 1.0%, 1.25%, 1.50%, 1.75%, 2.0%, 2.5%, 3.0%, 5%, 10%, 15%, 20%, 25%, 30%, 33%, 35%, 40%, 45% or 50%, Compositions of the invention will also comprise anything from 0.1% w/v of the anionic alkyl ether sulfate surfactant to 80% w/v of the anionic alkyl ether surfactant. In particular, the anionic alkyl ether sulfate surfactant (i.e. component (ii) of the liquid agrochemical composition of the invention) may be employed at, for example, a concentration of 0.1%, 0.125%, 0.2%, 0.25%, 0.3%, 0.33%, 0.5%, 0.66%, 0.7%, 0.75%, 1%, 1.5%, 3%, 5%, 10%, 15%, 20%, 25%, 30%, 33%, 40%, 50%, 60%, 66%, 75%, or 80%, all w/v.

Solvent or diluent, and optionally further standard formulation components as discussed above, will form the rest of the liquid agrochemical composition of the invention.

The compositions of the present invention may further comprise at least one additional pesticide. For example, the compounds according to the invention can also be used in combination with other herbicides or plant growth regulators. In a preferred embodiment the additional pesticide is a herbicide and/or herbicide safener.

Thus, compounds of Formula (I) can be used in combination with one or more other herbicides to provide various herbicidal mixtures. Specific examples of such mixtures include (wherein “I” represents a compound of Formula (I)): —I+acetochlor; I+acifluorfen (including acifluorfen-sodium); I+aclonifen; I+alachlor; I+alloxydim; I+ametryn; I+amicarbazone; I+amidosulfuron; I+aminocyclopyrachlor; I+aminopyralid; I+amitrole; I+asulam; I+atrazine; I+bensulfuron (including bensulfuron-methyl); I+bentazone; I+bicyclopyrone; I+bilanafos; I+bifenox; I+bispyribac-sodium; I+bixlozone; I+bromacil; I+bromoxynil; I+butachlor; I+butafenacil; I+cafenstrole; I+carfentrazone (including carfentrazone-ethyl); cloransulam (including cloransulam-methyl); I+chlorimuron (including chlorimuron-ethyl); I+chlorotoluron; I+cinosulfuron; I+chlorsulfuron; I+cinmethylin; I+clacyfos; I+clethodim; I+clodinafop (including clodinafop-propargyl); I+clomazone; I+clopyralid; I+cyclopyranil; I+cyclopyrimorate; I+cyclosulfamuron; I+cyhalofop (including cyhalofop-butyl); I+2,4-D (including the choline salt and 2-ethylhexyl ester thereof); I+2,4-DB; I+daimuron; I+desmedipham; I+dicamba (including the aluminum, aminopropyl, bis-aminopropylmethyl, choline, dichloroprop, diglycolamine, dimethylamine, dimethylammonium, potassium and sodium salts thereof); I+diclofop-methyl; I+diclosulam; I+diflufenican; I+difenzoquat; I+diflufenican; I+diflufenzopyr; I+dimethachlor; I+dimethenamid-P; I+diquat dibromide; I+diuron; I+esprocarb; I+ethalfluralin; I+ethofumesate; I+fenoxaprop (including fenoxaprop-P-ethyl); I+fenoxasulfone; I+fenquinotrione; I+fentrazamide; I+flazasulfuron; I+florasulam; I+florpyrauxifen; I+fluazifop (including fluazifop-P-butyl); I+flucarbazone (including flucarbazone-sodium); I+flufenacet; I+flumetralin; I+flumetsulam; I+flumioxazin; I+flupyrsulfuron (including flupyrsulfuron-methyl-sodium); I+fluroxypyr (including fluroxypyr-meptyl); I+fluthiacet-methyl; I+fomesafen; I+foramsulfuron; I+glufosinate (including the ammonium salt thereof); I+glyphosate (including the diammonium, isopropylammonium and potassium salts thereof); I+halauxifen (including halauxifen-methyl); I+halosulfuron-methyl; I+haloxyfop (including haloxyfop-methyl); I+hexazinone; I+hydantocidin; I+imazamox; I+imazapic; I+imazapyr; I+imazaquin; I+imazethapyr; I+indaziflam; I+iodosulfuron (including iodosulfuron-methyl-sodium); I+iofensulfuron; I+iofensulfuron-sodium; I+ioxynil; I+ipfencarbazone; I+isoproturon; I+isoxaben; I+isoxaflutole; I+lactofen; I+lancotrione; I+linuron; I+MCPA; I+MCPB; I+mecoprop-P; I+mefenacet; I+mesosulfuron; I+mesosulfuron-methyl; I+mesotrione; I+metamitron; I+metazachlor; I+methiozolin; I+metobromuron; I+metolachlor; I+metosulam; I+metoxuron; I+metribuzin; I+metsulfuron; I+molinate; I+napropamide; I+nicosulfuron; I+norflurazon; I+orthosulfamuron; I+oxadiargyl; I+oxadiazon; I+oxasulfuron; I+oxyfluorfen; I+paraquat dichloride; I+pendimethalin; I+penoxsulam; I+phenmedipham; I+picloram; I+picolinafen; I+pinoxaden; I+pretilachlor; I+primisulfuron-methyl; I+prodiamine; I+prometryn; I+propachlor; I+propanil; I+propaquizafop; I+propham; I+propyrisulfuron, I+propyzamide; I+prosulfocarb; I+prosulfuron; I+pyraclonil; I+pyraflufen (including pyraflufen-ethyl): I+pyrasulfotole; I+pyrazolynate, I+pyrazosulfuron-ethyl; I+pyribenzoxim; I+pyridate; I+pyriftalid; I+pyrimisulfan, I+pyrithiobac-sodium; I+pyroxasulfone; I+pyroxsulam; I+quinclorac; I+quinmerac; I+quizalofop (including quizalofop-P-ethyl and quizalofop-P-tefuryl); I+rimsulfuron; I+saflufenacil; I+sethoxydim; I+simazine; I+S-metolachlor; I+sulcotrione; I+sulfentrazone; I+sulfosulfuron; I+tebuthiuron; I+tefuryltrione; I+tembotrione; I+terbuthylazine; I+terbutryn; I+thiencarbazone; I+thifensulfuron; I+tiafenacil; I+tolpyralate; I+topramezone; I+tralkoxydim; I+triafamone; I+triallate; I+triasulfuron; I+tribenuron (including tribenuron-methyl); I+triclopyr; I+trifloxysulfuron (including trifloxysulfuron-sodium); I+trifludimoxazin; I+trifluralin; I+triflusulfuron; I+tritosulfuron; I+4-hydroxy-1-methoxy-5-methyl-3-[4-(trifluoromethyl)-2-pyridyl]imidazolidin-2-one; I+4-hydroxy-1,5-dimethyl-3-[4-(trifluoromethyl)-2-pyridyl]imidazolidin-2-one; I+5-ethoxy-4-hydroxy-1-methyl-3-[4-(trifluoromethyl)-2-pyridyl]imidazolidin-2-one; I+4-hydroxy-1-methyl-3-[4-(trifluoromethyl)-2-pyridyl]imidazolidin-2-one; I+4-hydroxy-1,5-dimethyl-3-[1-methyl-5-(trifluoromethyl)pyrazol-3-yl]imidazolidin-2-one; I+(4R)1-(5-tert-butylisoxazol-3-yl)-4-ethoxy-5-hydroxy-3-methyl-imidazolidin-2-one; I+3-[2-(3,4-dimethoxyphenyl)-6-methyl-3-oxo-pyridazine-4-carbonyl]bicyclo[3.2.1]octane-2,4-dione; I+2-[2-(3,4-dimethoxyphenyl)-6-methyl-3-oxo-pyridazine-4-carbonyl]-5-methyl-cyclohexane-1,3-dione; I+2-[2-(3,4-dimethoxyphenyl)-6-methyl-3-oxo-pyridazine-4-carbonyl]cyclohexane-1,3-dione; I+2-[2-(3,4-dimethoxyphenyl)-6-methyl-3-oxo-pyridazine-4-carbonyl]-5,5-dimethyl-cyclohexane-1,3-dione; I+6-[2-(3,4-dimethoxyphenyl)-6-methyl-3-oxo-pyridazine-4-carbonyl]-2,2,4,4-tetramethyl-cyclohexane-1,3,5-trione; I+2-[2-(3,4-dimethoxyphenyl)-6-methyl-3-oxo-pyridazine-4-carbonyl]-5-ethyl-cyclohexane-1,3-dione; I+2-[2-(3,4-dimethoxyphenyl)-6-methyl-3-oxo-pyridazine-4-carbonyl]-4,4,6,6-tetramethyl-cyclohexane-1,3-dione; I+2-[6-cyclopropyl-2-(3,4-dimethoxyphenyl)-3-oxo-pyridazine-4-carbonyl]-5-methyl-cyclohexane-1,3-dione; I+3-[6-cyclopropyl-2-(3,4-dimethoxyphenyl)-3-oxo-pyridazine-4-carbonyl]bicyclo[3.2.1]octane-2,4-dione; I+2-[6-cyclopropyl-2-(3,4-dimethoxyphenyl)-3-oxo-pyridazine-4-carbonyl]-5,5-dimethyl-cyclohexane-1,3-dione; I+6-[6-cyclopropyl-2-(3,4-dimethoxyphenyl)-3-oxo-pyridazine-4-carbonyl]-2,2,4,4-tetramethyl-cyclohexane-1,3,5-trione; I+2-[6-cyclopropyl-2-(3,4-dimethoxyphenyl)-3-oxo-pyridazine-4-carbonyl]cyclohexane-1,3-dione; I+4-[2-(3,4-dimethoxyphenyl)-6-methyl-3-oxo-pyridazine-4-carbonyl]-2,2,6,6-tetramethyl-tetrahydropyran-3,5-dione and I+4-[6-cyclopropyl-2-(3,4-dimethoxyphenyl)-3-oxo-pyridazine-4-carbonyl]-2,2,6,6-tetramethyl-tetrahydropyran-3,5-dione.

The mixing partners of the compound of Formula (I) may also be in the form of esters or salts, as mentioned e.g. in The Pesticide Manual, Fourteenth Edition, British Crop Protection Council, 2006.

Compounds of Formula (I) can also be used in mixtures with other agrochemicals such as fungicides, nematicides or insecticides, examples of which are given in The Pesticide Manual, to form further compositions of the invention. The mixing ratio of the compound of Formula (I) to the mixing partner is preferably from 1:100 to 1000:1.

Compounds of Formula (I) as described herein may also be combined with herbicide safeners. Preferred combinations (wherein “I” represents a compound of Formula (I)) include: —I+benoxacor, I+cloquintocet (including cloquintocet-mexyl); I+cyprosulfamide; I+dichlormid; I+fenchlorazole (including fenchlorazole-ethyl); I+fenclorim; I+fluxofenim; I+furilazole I+isoxadifen (including isoxadifen-ethyl); I+mefenpyr (including mefenpyr-diethyl); I+metcamifen; I+N-(2-methoxybenzoyl)-4-[(methylaminocarbonyl)amino] benzenesulfonamide and I+oxabetrinil.

Particularly preferred are mixtures of a compound of formula (I) with cyprosulfamide, isoxadifen (including isoxadifen-ethyl), cloquintocet (including cloquintocet-mexyl) and/or N-(2-methoxybenzoyl)-4-[(methyl-aminocarbonyl)amino]benzenesulfonamide. The safeners of the compound of formula (I) may also be in the form of esters or salts, as mentioned e.g. in The Pesticide Manual, 14^{th} Edition (BCPC), 2006. The reference to cloquintocet-mexyl also applies to a lithium, sodium, potassium, calcium, magnesium, aluminium, iron, ammonium, quaternary ammonium, sulfonium or phosphonium salt thereof as disclosed in WO 02/34048, and the reference to fenchlorazole-ethyl also applies to fenchlorazole, etc. Preferably the mixing ratio of compound of formula (I) to safener is from 100:1 to 1:10, especially from 20:1 to 1:1.

The mixtures described herein can advantageously be used in a composition of the invention (in which case “active ingredient” relates to the respective mixture of compound of Formula (I) with the safener).

As stated herein, compounds of Formula (I) are useful as herbicides. The present invention therefore further comprises a method for controlling unwanted plants comprising applying to the said plants or a locus comprising them, an effective amount of a herbicidal composition of the invention, or an effective amount of a compound of Formula (IA) or Formula (IB). ‘Controlling’ means killing, reducing or retarding growth or preventing or reducing germination. Generally the plants to be controlled are unwanted plants (weeds). ‘Locus’ means the area in which the plants are growing or will grow.

The rates of application of compounds of Formula (I) may vary within wide limits and depend on the nature of the soil, the method of application (pre-emergence; post-emergence; application to the seed furrow; no tillage application etc.), the crop plant, the weed(s) to be controlled, the prevailing climatic conditions, and other factors governed by the method of application, the time of application and the target crop. The compounds of Formula (I) as described herein are generally applied at a rate of from 10 to 2000 g/ha, especially from 50 to 1000 g/ha, and in particular at 50, 100, 125, 150, 50, 300, 400, 500, 600, 750, 800 or 1000 g/ha.

The rates of application vary within wide limits and depend on the nature of the soil, the method of application, the crop plant, the pest to be controlled, the prevailing climatic conditions, and other factors governed by the method of application, the time of application and the target plant. As a general guideline compounds of Formula (I) may be applied at a rate as described herein, in a volume of from 1 to 2000 I/ha, especially from 10 to 1000 I/ha.

The application is generally made by spraying the composition, typically by tractor mounted sprayer for large areas, but other methods such as drip or drench can also be used.

Useful plants in which the composition according to the invention can be used include crops such as cereals, for example barley and wheat, cotton, oilseed rape, sunflower, maize, rice, soybeans, sugar beet, sugar cane and turf.

Crop plants can also include trees, such as fruit trees, palm trees, coconut trees or other nuts. Also included are vines such as grapes, fruit bushes, fruit plants and vegetables.

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour). Other useful plants include turf grass for example in golf-courses, lawns, parks and roadsides, or grown commercially for sod, and ornamental plants such as flowers or bushes.

Compounds of formula (I) and compositions of the invention can typically be used to control a wide variety of monocotyledonous and dicotyledonous weed species. Examples of monocotyledonous species that can typically be controlled include Alopecurus myosuroides, Avena fatua, Brachiaria plantaginea, Bromus tectorum, Cyperus esculentus, Digitaria sanguinalis, Echinochloa crus-galli, Lolium perenne, Lolium multiflorum, Panicum miliaceum, Poa annua, Setaria viridis, Setaria faberi and Sorghum bicolor. Examples of dicotyledonous species that can be controlled include Abutilon theophrasti, Amaranthus retroflexus, Bidens pilosa, Chenopodium album, Euphorbia heterophylla, Galium aparine, Ipomoea hederacea, Kochia scoparia, Polygonum convolvulus, Sida spinosa, Sinapis arvensis, Solanum nigrum, Stellaria media, Veronica persica and Xanthium strumarium.

Compounds/compositions of the invention are particularly useful in non-selective burn-down applications, and as such may also be used to control volunteer or escape crop plants.

Various aspects and embodiments of the present invention will now be illustrated in more detail by way of example. It will be appreciated that modification of detail may be made without departing from the scope of the invention, and thus that the Examples which follow serve to illustrate, but do not limit, the invention

### LIST OF ABBREVIATIONS

Boc=tert-butyloxycarbonyl
br=broad
CDCl₃=chloroform-d
CD₃OD=methanol-d
° C.=degrees Celsius
D₂O=water-d
DCM=dichloromethane
d=doublet
dd=double doublet
dt=double triplet
DMSO=dimethylsulfoxide
EtOAc=ethyl acetate
h=hour(s)
HCl=hydrochloric acid
HPLC=high-performance liquid chromatography (description of the apparatus and the methods used for HPLC are given below)
m=multiplet
M=molar
min=minutes
MHz=mega hertz
mL=millilitre
mp=melting point
ppm=parts per million
q=quartet
quin=quintet
rt=room temperature
s=singlet
t=triplet
THF=tetrahydrofuran

### LC/MS=Liquid Chromatography Mass Spectrometry

### Preparative Reverse Phase HPLC Method:

Compounds purified by mass directed preparative HPLC using ES+/ES− on a Waters Fraction Lynx Autopurification system comprising a 2767 injector/collector with a 2545 gradient pump, two 515 isocratic pumps, SFO, 2998 photodiode array (Wavelength range (nm): 210 to 400), 2424 ELSD and QDa mass spectrometer. A Waters Atlantis T3 5 micron 19×10 mm guard column was used with a Waters Atlantis T3 OBD, 5 micron 30×100 mm prep column.

### Ionisation Method:

Electrospray positive and negative: Cone (V) 20.00, Source Temperature (° C.) 120, Cone Gas Flow (L/Hr.) 50
Mass range (Da): positive 100 to 800, negative 115 to 800.
The preparative HPLC was conducted using an 11.4 minute run time (not using at column dilution, bypassed with the column selector), according to the following gradient table:

| Time | Solvent A | Solvent B | Flow (ml/ |
|---|---|---|---|
| (mins) | (%) | (%) | min) |
| 0.00 | 100 | 0 | 35 |
| 2.00 | 100 | 0 | 35 |
| 2.01 | 100 | 0 | 35 |
| 7.0 | 90 | 10 | 35 |
| 7.3 | 0 | 100 | 35 |
| 9.2 | 0 | 100 | 35 |
| 9.8 | 99 | 1 | 35 |
| 11.35 | 99 | 1 | 35 |
| 11.40 | 99 | 1 | 35 |

515 pump 0 ml/min Acetonitrile (ACD)
515 pump 1 ml/min 90% Methanol/10% Water (make up pump)
Solvent A: Water with 0.05% Trifluoroacetic Acid
Solvent B: Acetonitrile with 0.05% Trifluoroacetic Acid

### PREPARATION EXAMPLES

### Example 1 Preparation of (2,8-dimethylcinnolin-2-ium-4-yl)-methoxy-phosphinate A15

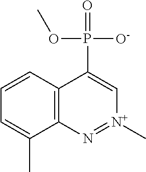 [SMILES: COP(=O)([O-])c1c[n+](C)nc2c(C)cccc12]

### Step 1: Preparation of 1-(2-amino-3-methyl-phenyl)ethanone

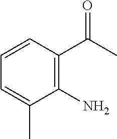

A solution of 2-amino-3-methyl-benzoic acid (20 g) in tetrahydrofuran (500 mL) was cooled to 0° C. and methyl lithium (1.6M in diethylether, 413 mL) was added drop wise, keeping the temperature at 0° C., over 30 minutes. The reaction mixture was stirred at 0° C. for a further 4 hours then quenched with saturated aqueous ammonium chloride (100 mL) and extracted with ethyl acetate (400 mL). The organic layer was washed with brine (200 mL), dried over sodium sulfate, then concentrated and purified by silica gel chromatography eluting with 15% ethyl acetate in iso-hexane to give 1-(2-amino-3-methyl-phenyl)ethanone as a pale yellow liquid.

¹H NMR (300 MHz, DMSO-d₆) 7.65-7.63 (d, 1H), 7.19-7.17 (d, 1H), 7.05 (bs, 2H), 6.52-6.48 (t, 1H), 2.51 (s, 3H), 2.09 (s, 3H)

### Step 2: Preparation of 8-methyl-1H-cinnolin-4-one

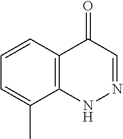

To an ice cold solution of 1-(2-amino-3-methyl-phenyl)ethanone (15 g) in glacial acetic acid (12 mL) was added water (40 mL) and concentrated aqueous hydrochloric acid (21 mL) over 15 minutes, maintaining a reaction temperature of 0° C. To this was added an ice cold solution of sodium nitrite (7.61 g) in water (30 mL) over 15 minutes, again maintaining a reaction temperature of 0° C. The reaction mixture was stirred at 0° C. for 1 hour, followed by addition of urea (604 mg) over 10 minutes then further stirring at 0° C. for 1 hour. To this mixture was then added a solution of sodium acetate (103 g) in water (300 mL) and dichloromethane (140 mL) over 30 minutes followed by stirring at room temperature for 16 hours. The reaction mixture was filtered and the resulting solid was washed with dichloromethane (2×100 mL) and dried to afford 8-methyl-1H-cinnolin-4-one as a red solid.

¹H NMR (400 MHz, DMSO-d₆) 13.09 (s, 1H), 7.91-7.89 (d, 1H), 7.82 (s, 1H), 7.62-7.60 (d, 1H), 7.34-7.31 (t, 1H), 2.54 (s, 3H)

### Step 3: Preparation of 4-chloro-8-methyl-cinnoline

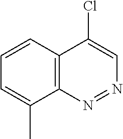

To a mixture of 8-methyl-1H-cinnolin-4-one (5.82 g) in chlorobenzene (150 mL) was added phosphorus oxychloride (5.0 mL) drop wise at room temperature over 10 minutes. To this was added 2-methyl pyridine (1 g) over 5 minutes and the resulting reaction mixture was heated at 140° C. for 1 hour. The reaction mixture was cautiously poured into crushed ice and the resulting mixture basified with saturated aqueous sodium carbonate solution. The reaction mass was extracted with dichloromethane (2×150 mL) and the combined organic phase was dried over sodium sulfate, concentrated then purified by silica gel chromatography eluting with 20% ethyl acetate in iso-hexane to give 4-chloro-8-methyl-cinnoline as a dark brown solid.

¹H NMR (300 MHz, DMSO-d₆) 9.60 (s, 1H), 8.07-8.05 (d, 1H), 7.96-7.89 (m, 2H), 2.96 (s, 3H)

### Step 4: Preparation of 8-methyl-4-(p-tolylsulfonyl)cinnoline

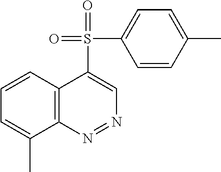 [SMILES: Cc1ccc(S(=O)(=O)c2cnnc3c(C)cccc23)cc1]

To a mixture of 4-chloro-8-methyl-cinnoline (1.5 g) and N,N-dimethylformamide (20 mL) was added sodium p-toluenesulfinate (1.8 g) at room temperature. The reaction mixture was stirred at room temperature for 4 hours then diluted with water (50 mL) and extracted with ethyl acetate (2×75 mL). The combined organic layers were dried over anhydrous sodium sulfate and concentrated to afford 8-methyl-4-(p-tolylsulfonyl)cinnoline as a pale yellow solid.

¹H NMR (400 MHz, DMSO-d₆) 9.89 (s, 1H), 8.44-8.42 (d, 1H), 8.04-7.90 (m, 4H), 7.46-7.44 (d, 2H), 2.97 (s, 3H), 2.35 (s, 3H)

### Step 5: Preparation of 4-dimethoxyphosphoryl-8-methyl-cinnoline

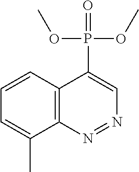 [SMILES: COP(=O)(OC)c1cnnc2c(C)cccc12]

To a mixture of 8-methyl-4-(p-tolylsulfonyl)cinnoline (2 g), caesium carbonate (4.3 g) and N,N-dimethylformamide (20 mL) was added dimethyl phosphite (0.88 g) at room temperature. The reaction mixture was stirred at room temperature for 2 hours and then diluted with water (50.0 mL) and extracted with ethyl acetate (2×75 mL). The combined organic layers were dried over anhydrous sodium sulfate and concentrated to afford 4-dimethoxyphosphoryl-8-methyl-cinnoline as a pale yellow solid.

¹H NMR (400 MHz, DMSO-d₆) 9.57-9.55 (d, 1H), 8.25-8.23 (d, 1H), 7.98-7.90 (m, 2H), 3.81-3.78 (d, 6H), 2.99 (s, 3H)

### Step 6: Preparation of (2,8-dimethylcinnolin-2-ium-4-yl)-methoxy-phosphinate A15

A mixture of 4-dimethoxyphosphoryl-8-methyl-cinnoline (1 g) and methanol (30 mL) was heated at 90° C. for 16 hours. The reaction mixture was cooled to room temperature, concentrated then triturated with acetone (20 mL) to afford (2,8-dimethylcinnolin-2-ium-4-yl)-methoxy-phosphinate as a light green solid.

¹H NMR (300 MHz, D₂O) 9.46-9.43 (d, 1H), 8.56-8.53 (d, 1H), 8.21-8.16 (t, 1H), 8.08-8.05 (d, 1H), 4.86 (s, 3H), 3.56-3.53 (d, 3H), 2.86 (s, 3H)

### Example 2 Preparation of allyloxy-(2-methylcinnolin-2-ium-4-yl)phosphinate A5

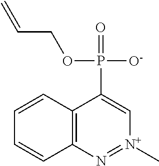 [SMILES: C=CCOP(=O)([O-])c1c[n+](C)nc2ccccc12]

### Step 1: Preparation of methoxy-(2-methylcinnolin-2-ium-4-yl)phosphinate

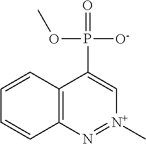 [SMILES: COP(=O)([O-])c1c[n+](C)nc2ccccc12]

To a suspension of 4-dimethoxyphosphorylcinnoline (5 g) in acetone (100 mL) was added iodomethane (13.1 mL) drop wise and the resulting reaction mixture was stirred for 60 hours at room temperature. The resulting precipitate was filtered, washed with acetone (2×) then dried to give methoxy-(2-methylcinnolin-2-ium-4-yl)phosphinate.

¹H NMR (400 MHz, D₂O) 9.50 (d, 1H), 8.74 (d, 1H), 8.56 (d, 1H), 8.26-8.37 (m, 2H), 4.87 (s, 3H), 3.56 (d, 3H)

### Step 2: Preparation of allyloxy-(2-methylcinnolin-2-ium-4-yl)phosphinate A5

To a suspension of methoxy-(2-methylcinnolin-2-ium-4-yl)phosphinate (95 mg) in dichloromethane was added oxalyl chloride (160 mg) drop wise. The reaction mixture was warmed to 35° C. followed by addition of allyl alcohol (280 mg). After standing at room temperature overnight, the reaction mixture was concentrated and purified by preparative reverse phase HPLC to give an orange coloured gum which was triturated with diethyl ether to give allyloxy-(2-methylcinnolin-2-ium-4-yl)phosphinate as a cream solid.

¹H NMR (400 MHz, D₂O) 9.42 (d, 1H), 8.70 (d, 1H), 8.51-8.46 (m, 1H), 8.29-8.19 (m, 2H), 5.81-5.71 (m, 1H), 5.21-5.13 (m, 1H), 5.06-5.01 (m, 1H), 4.80 (s, 3H), 4.34-4.28 (m, 2H)

### Example 3 Preparation of (2,3-dimethylcinnolin-2-ium-4-yl)-methoxy-phosphinate A9

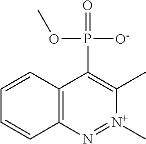 [SMILES: COP(=O)([O-])c1c(C)[n+](C)nc2ccccc12]

### Step 1: Preparation of 3-methylcinnolin-4-ol

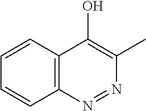

To an ice cold solution of 1-(2-aminophenyl)propan-1-one (22 g) in glacial acetic acid (22 mL) was added 2M aqueous hydrochloric acid (66 mL) and water (22 mL). The mixture was cooled to 0° C. and a solution of sodium nitrite (11.192 g) in water (44 mL) was added slowly, keeping the temperature between 0° C. and 5° C. The mixture was stirred at 0° C. for one hour and urea (0.886 g) was added and stirred for another hour. To this was added a solution of sodium acetate (159.19 g) in water (440 mL) followed by dichloromethane (110 mL) at 0° C. and then the mixture was allowed to warm to room temperature and stirred for 15 hours. The reaction mass was filtered and the light brown solid was washed sequentially with water (50 mL), dichloromethane (20 mL) and hexane (20 mL) and dried to give 3-methylcinnolin-4-ol.

¹H NMR (400 MHz, CDCl₃) 12.50 (br. s., 1H) 8.15 (d, 1H) 7.48-7.60 (m, 1H) 7.39-7.47 (m, 1H) 7.19-7.31 (m, 1H) 2.34-2.35 (m, 3H)

### Step 2: Preparation of 4-chloro-3-methyl-cinnoline

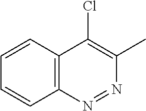

To a mixture of 3-methylcinnolin-4-ol (9 g) and chlorobenzene (90 mL), under a nitrogen atmosphere, was added 2-methylpyridine (1.0466 g) drop wise at room temperature. Phosphorus oxychloride (7.936 mL) was then added drop wise and the resulting mixture was heated at reflux for 2 hours. The reaction mass was poured cautiously into ice cold water and the resulting mixture was basified with saturated aqueous sodium carbonate solution. The reaction mixture was extracted with dichloromethane (3×50 mL) and the combined organic phase were concentrated then purified by silica gel chromatography eluting with a 3:7 ration of ethyl acetate in iso-hexane to give 4-chloro-3-methyl-cinnoline.

¹H NMR (400 MHz, CDCl₃) 8.48 (m, 1H), 8.12 (m, 1H), 7.74-7.84 (m, 2H), 3.03 (s, 3H)

### Step 3: Preparation of 3-methyl-4-(p-tolylsulfonyl)cinnoline

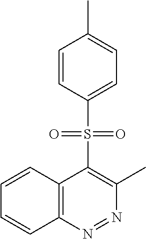 [SMILES: Cc1ccc(S(=O)(=O)c2c(C)nnc3ccccc23)cc1]

A mixture of 4-chloro-3-methyl-cinnoline (0.5 g) and acetonitrile (6 mL), under a nitrogen atmosphere, was cooled to 0° C. and sodium p-toluenesulfinate (0.549 g) was added in one portion. The mixture was stirred cold for 1 hour and then allowed to warm to room temperature and stirred overnight. The reaction mixture was partitioned between water and ethyl acetate (100 mL), then extracted further ethyl acetate (2×100 mL). The combined organic layers were dried over sodium sulphate and concentrated to give 3-methyl-4-(p-tolylsulfonyl)cinnoline.

¹H NMR (400 MHz, CDCl₃) 9.15 (d, 1H), 8.62 (d, 1H), 7.81-7.92 (m, 4H), 7.32 (d, 2H), 3.35 (s, 3H), 2.41 (s, 3H)

### Step 4: Preparation of 4-dimethoxyphosphoryl-3-methyl-cinnoline

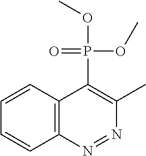 [SMILES: COP(=O)(OC)c1c(C)nnc2ccccc12]

A stirred suspension of sodium hydride (0.30 g) in tetrahydrofuran (60 mL), under a nitrogen atmosphere, was cooled to 0° C. and dimethyl phosphite (0.56 mL) was added drop wise. After stirring for 30 minutes at 0° C., a solution of 3-methyl-4-(p-tolylsulfonyl)cinnoline (1.5 g) in tetrahydrofuran (40 mL) was added drop wise. The reaction was slowly warmed to room temperature and stirred overnight. The reaction mixture was diluted with water (50 mL) and extracted twice with dichloromethane (2×20 mL). The organic layers were concentrated then purified by silica gel chromatography eluting with 0-30% ethyl acetate in cyclohexane to give 4-dimethoxyphosphoryl-3-methyl-cinnoline

¹H NMR (400 MHz, CDCl₃) 8.91-8.96 (m, 1H) 8.56-8.61 (m, 1H) 7.80-7.86 (m, 2H) 3.86 (s, 3H) 3.84 (s, 3H) 3.26 (s, 3H)

### Step 5: Preparation of (2,3-dimethylcinnolin-2-ium-4-yl)-methoxy-phosphinate A9

To a mixture of 4-dimethoxyphosphoryl-3-methyl-cinnoline (0.5 g) and acetone (10 mL) was added iodomethane (2.5 mL) drop wise. The reaction mixture was stirred at room temperature for 60 hours. The resulting precipitate was filtered off and dried to give (2,3-dimethylcinnolin-2-ium-4-yl)-methoxy-phosphinate.

¹H NMR (400 MHz, D₂O) 9.09 (d, 1H), 8.36 (d, 1H), 8.06-8.19 (m, 2H), 6.31 (s, 3H), 3.43 (d, 3H), 3.23 (s, 3H)

Additional compounds in Table A were prepared by analogous procedures to those described above in Examples 1 to 3, from appropriate starting materials.

TABLE A
Physical data for Compounds Formula (I)

| Cmpd No. | Structure | ¹H NMR |
|---|---|---|
| 1 | 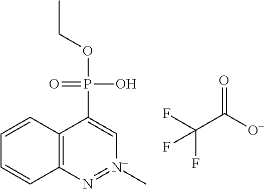 [SMILES: CCOP(=O)(O)c1c[n+](C)nc2ccccc12 ; O=C([O-])C(F)(F)F] | (400 MHz, CD3OD) 9.65 (d, 1H), 9.05-9.01 (m, 1H), 8.62-8.57 (m, 1H), 8.39-8.30 (m, 2H), 4.98-4.92 (m, 3H), 4.03-3.92 (m, 2H), 1.22 (t, 3H) (POH proton missing) |
| 2 | 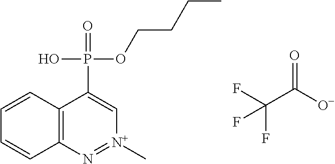 [SMILES: CCCCOP(=O)(O)c1c[n+](C)nc2ccccc12 ; O=C([O-])C(F)(F)F] | (400 MHz, CD3OD) 9.64 (d, 1H), 9.02-8.97 (m, 1H), 8.64-8.59 (m, 1H), 8.41-8.31 (m, 2H), 4.94 (s, 3H), 3.93 (q, 2H), 1.63-1.53 (m, 2H), 1.41- 1.29 (m, 2H), 0.86 (t, 3H) (POH proton missing) |
| 3 | 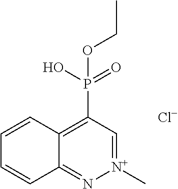 [SMILES: CCOP(=O)(O)c1c[n+](C)nc2ccccc12 ; [Cl-]] | (400 MHz, OD3OD) 9.74 (d, 1H), 8.93 (d, 1H), 8.66 (d, 1H), 8.47-8.34 (m, 2H), 4.96 (s, 3H), 4.16-4.06 (m, 2H), 1.29 (t, 3H) (POH proton missing) |
| 4 | 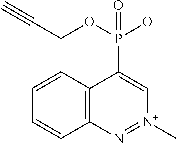 [SMILES: C#CCOP(=O)([O-])c1c[n+](C)nc2ccccc12] | (400 MHz, D2O) 9.50 (d, 1H), 8.73-8.69 (m, 1H), 8.53-8.48 (m, 1H), 8.32-8.20 (m, 2H), 4.82 (s, 3H), 4.52 (dd, 2H), 2.59 (t, 1H) |
| 5 | 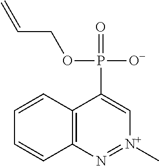 [SMILES: C=CCOP(=O)([O-])c1c[n+](C)nc2ccccc12] | (400 MHz, D2O) 9.42 (d, 1H), 8.70 (d, 1H), 8.51-8.46 (m, 1H), 8.29-8.19 (m, 2H), 5.81-5.71 (m, 1H), 5.21-5.13 (m, 1H), 5.06-5.01 (m, 1H), 4.80 (s, 3H), 4.34-4.28 (m, 2H) |
| 6 | 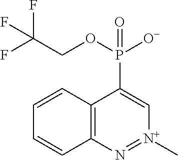 [SMILES: C[n+]1cc(P(=O)([O-])OCC(F)(F)F)c2ccccc2n1] | (400 MHz, D2O) 9.45 (d, 1H), 8.67 (d, 1H), 8.52-8.47 (m, 1H), 8.30-8.19 (m, 2H), 4.81 (s, 3H), 4.34-4.24 (m, 2H) |
| 7 | 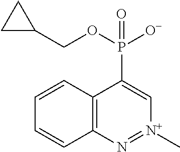 [SMILES: C[n+]1cc(P(=O)([O-])OCC2CC2)c2ccccc2n1] | (400 MHz, D2O) 9.43-9.38 (m, 1H), 8.72-8.67 (m, 1H), 8.49-8.44 (m, 1H), 8.28-8.16 (m, 2H), 4.78 (s, 3H), 3.66-3.58 (m, 2H), 0.93-0.81 (m, 1H), 0.30-0.22 (m, 2H), 0.02-0.04 (m, 2H) |
| 8 | 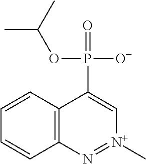 [SMILES: CC(C)OP(=O)([O-])c1c[n+](C)nc2ccccc12] | (400 MHz, D2O) 9.40 (d, 1H), 8.71-8.67 (m, 1H), 8.51-8.46 (m, 1H), 8.29-8.17 (m, 2H), 4.80 (s, 3H), 4.46-4.36 (m, 1H), 1.06 (s, 3H), 1.05 (s, 3H) |
| 9 | 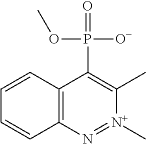 [SMILES: COP(=O)([O-])c1c(C)[n+](C)nc2ccccc12] | (400 MHz, D2O) 9.09 (d, 1H), 8.36 (d, 1H), 8.06-8.19 (m, 2H), 6.31 (s, 3H), 3.43 (d, 3H), 3.23 (s, 3H) |
| 10 | 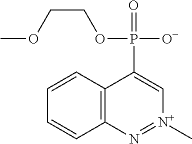 | (400 MHz, D2O) 9.48-9.44 (m, 1H), 8.73-8.69 (m, 1H), 8.54-8.48 (m, 1H), 8.32-8.20 (m, 2H), 4.82 (s, 3H), 3.97-3.91 (m, 2H), 3.49-3.43 (m, 2H), 3.05 (s, 3H) |
| 11 | 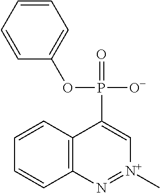 [SMILES: C[n+]1cc(P(=O)([O-])Oc2ccccc2)c2ccccc2n1] | (400 MHz, D2O) 9.48-9.44 (m, 1H), 8.80-8.75 (m, 1H), 8.56-8.51 (m, 1H), 8.34-8.23 (m, 2H), 7.20-7.14 (m, 2H), 7.09-7.03 (m, 1H), 6.89-6.84 (m, 2H), 4.79 (s, 3H) |
| 12 | 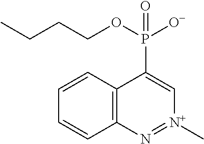 [SMILES: CCCCOP(=O)([O-])c1c[n+](C)nc2ccccc12] | (400 MHz, D2O) 9.40 (d, 1H), 8.68 (d, 1H), 8.50-8.44 (m, 1H), 8.28-8.17 (m, 2H), 4.80 (s, 3H), 3.80-3.73 (m, 2H), 1.44-1.36 (m, 2H), 1.19-1.10 (m, 2H), 0.64 (t, 3H) |
| 13 | 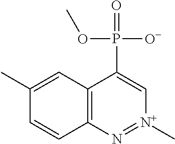 | (400 MHz, CD3OD) 9.42-9.40 (d, 1H), 8.69 (s, 1H), 8.37-8.35 (dd, 1H), 8.09-8.06 (dd, 1H), 4.77 (s, 3H), 3.52-3.49 (d, 3H), 2.68 (s, 3H) |
| 14 | 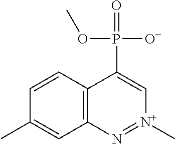 | (300 MHz, CD3OD) 9.45-9.42 (d, 1H), 8.83- 8.80 (d, 1H), 8.24 (s, 1H), 8.12-8.10 (d, 1H), 4.79 (s, 3H), 3.52-3.48 (d, 3H), 2.64 (s, 3H) |
| 15 | 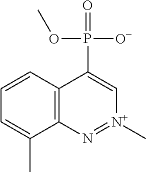 [SMILES: COP(=O)([O-])c1c[n+](C)nc2c(C)cccc12] | (300 MHz, D2O) 9.46-9.43 (d, 1H), 8.56-8.53 (d, 1H), 8.21-8.16 (t, 1H), 8.08-8.05 (d, 1H), 4.86 (s, 3H), 3.56-3.53 (d, 3H), 2.86 (s, 3H) |
| 16 | 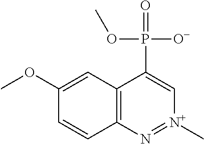 | (400 MHz, CD3OD) 9.26-9.24 (d, 1H), 8.33- 8.31 (dd, 1H), 8.13-8.12 (d, 1H), 7.80-7.77 (dd, 1H), 4.67 (s, 3H), 4.09 (s, 3H), 3.52-3.49 (d, 3H) |
| 17 | 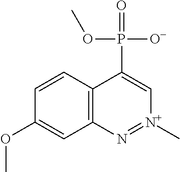 [SMILES: COc1ccc2c(P(=O)([O-])OC)c[n+](C)nc2c1] | (400 MHz, CD3OD) 9.369.34 (d, 1H), 8.99-8.97 (d, 1H), 7.76-7.73 (dd, 1H), 7.58 (s, 1H), 4.83 (s, 3H), 4.14 (s, 3H), 3.53-3.51 (d, 3H) |
| 18 | 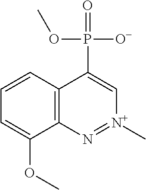 [SMILES: COc1cccc2c(P(=O)([O-])OC)c[n+](C)nc12] | (300 MHz, CD3OD) 9.41-9.38 (d, 1H), 8.39- 8.36 (d, 1H), 8.20-8.15 (t, 1H), 7.56-7.53 (d, 1H), 4.77 (s, 3H), 4.10 (s, 3H), 3.15-3.47 (d, 3H) |
| 19 | 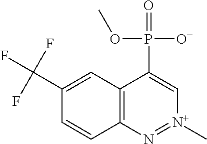 [SMILES: COP(=O)([O-])c1c[n+](C)nc2ccc(C(F)(F)F)cc12] | (400 MHz, CD3OD) 9.71-9.69 (d, 1H), 9.33 (s, 1H), 8.70-8.68 (d, 1H), 8.41-8.38 (dd, 1H), 4.90 (s, 3H), 3.55-3.52 (d, 3H) |
| 20 | 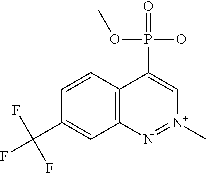 [SMILES: COP(=O)([O-])c1c[n+](C)nc2cc(C(F)(F)F)ccc12] | (300 MHz, D2O) 9.64-9.61 (d, 1H), 8.96 (s, 1H), 8.91-8.88 (d, 1H), 8.50-8.47 (d, 1H), 4.91 (s, 3H), 3.563.52 (d, 3H) |
| 21 | 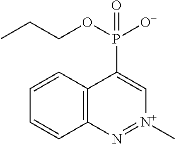 [SMILES: CCCOP(=O)([O-])c1c[n+](C)nc2ccccc12] | (400 MHz, D2O) 9.41 (d, 1H), 8.70 (d, 1H), 8.52-8.46 (m, 1H), 8.30-8.18 (m, 2H), 4.81 (s, 3H), 3.73 (q, 2H), 1.57-1.36 (m, 2H), 0.71 (t, 3H) |
| 22 | 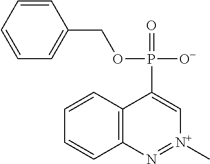 [SMILES: C[n+]1cc(P(=O)([O-])OCc2ccccc2)c2ccccc2n1] | (400 MHz, D2O) 9.12 (d, 1H), 8.58-8.53 (m, 1H), 8.37-8.32 (m, 1H), 8.20-8.11 (m, 2H), 6.97-6.81 (m, 5H), 4.89-4.81 (m, 2H), 4.66 (s, 3H) |
| 23 | 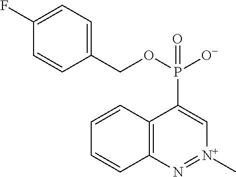 [SMILES: C[n+]1cc(P(=O)([O-])OCc2ccc(F)cc2)c2ccccc2n1] | (400 MHz, D2O) 9.23 (br d, 1H), 8.65-8.48 (m, 1H), 8.48-8.31 (m, 1H), 8.27-8.12 (m, 2H), 7.01-6.93 (m, 2H), 6.67-6.57 (m, 2H), 4.84 (br d, 2H), 4.73 (s, 3H) |
| 24 | 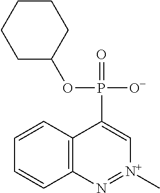 [SMILES: C[n+]1cc(P(=O)([O-])OC2CCCCC2)c2ccccc2n1] | (400 MHz, D2O) 9.46 (d, 1H) 8.77 (d, 1H) 8.55 (d, 1H) 8.25-8.35 (m, 2H) 4.87 (s, 3H) 4.16 (dd, 1H) 1.64 (d, 2H) 1.56 (d, 2H) 1.27-1.41 (m, 3H) 1.06-1.20 (m, 3H) |
| 25 | 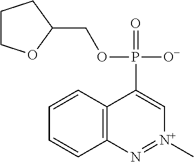 [SMILES: C[n+]1cc(P(=O)([O-])OCC2CCCO2)c2ccccc2n1] | (400 MHz, D2O) 9.53 (d, 1H) 8.77 (d, 1H) 8.57 (d, 1H) 8.26-8.38 (m, 2H) 4.88 (s, 3H) 4.02- 4.05 (m, 1H) 3.88-3.96 (m, 1H) 3.76-3.85 (m, 1H) 3.57-3.67 (m, 2H) 1.74-1.95 (m, 3H) 1.53- 1.63 (m, 1H) |
| 26 | 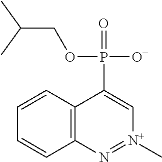 [SMILES: CC(C)COP(=O)([O-])c1c[n+](C)nc2ccccc12] | (400 MHz, D2O) 9.48 (d, 1H), 8.78 (d, 1H), 8.58 (d, 1H), 8.27-8.38 (m, 2H), 4.89 (s, 3H), 3.61 (t, 2H), 1.74-1.84 (m, 1H), 0.80 (s, 3H), 0.78 (s, 3H) |
| 27 | 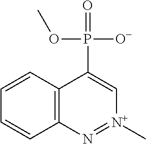 [SMILES: COP(=O)([O-])c1c[n+](C)nc2ccccc12] | (400 MHz, CD₃OD) 9.62 (d, 1H), 9.05-8.98 (m, 1H), 8.62-8.56 (m, 1H), 8.38-8.29 (m, 2H), 4.93 (s, 3H), 3.61 (d, 3H) |

### Biological Examples

### Post-Emergence Efficacy

Seeds of a variety of test species were shown in standard soil in pots. After cultivation for 14 days (post-emergence) under controlled conditions in a glasshouse (at 24/16° C., day/night; 14 hours light; 65% humidity), the plants were sprayed with an aqueous spray solution derived from the dissolution of the technical active ingredient for each of compounds 1 to 26 from Table A above, in a small amount of acetone and a special solvent and emulsifier mixture referred to as IF50 (11.12% Emulsogen EL360 TM+44.44% N-methylpyrrolidone+44.44% Dowanol DPM glycol ether), to create a 50 g/I solution which was then diluted to required concentration using 0.25% or 1% Empicol ESC70 (Sodium lauryl ether sulphate)+1% ammonium sulphate in water as diluent. These spray test compositions are described as composition numbers C1 to C26, with the numerical value corresponding to the compound number from Table A.

The test plants were then grown in a glasshouse under controlled conditions (at 24/16° C., day/night; 14 hours light; 65% humidity) and watered twice daily. After 13 days the test was evaluated (100=total damage to plant; 0=no damage to plant).

The results are shown in Table B (below). A value of n/a indicates that this combination of weed and test compound was not tested/assessed.

### Test Plants:

Ipomoea hederacea (IPOHE), Euphorbia heterophylla (EPHHL), Chenopodium album (CHEAL), Amaranthus palmeri (AMAPA), Lolium perenne (LOLPE), Digitaria sanguinalis (DIGSA), Eleusine indica (ELEIN), Echinochloa crus-galli (ECHCG), Setaria faberi (SETFA)

TABLE B
Control of weed species by compositions of the invention after post-emergence application

| Composition | Application | | | | | | | | | |
|---|---|---|---|---|---|---|---|---|---|---|
| number | Rate g/Ha | AMAPA | CHEAL | EPHHL | IPOHE | ELEIN | LOLPE | DIGSA | SETFA | ECHCG |
| C1 | 1000 | 90 | 100 | 100 | 100 | 90 | 60 | 90 | 80 | 70 |
| C2 | 500 | 60 | 70 | 100 | 80 | 40 | 30 | 60 | 60 | 30 |
| C3 | 1000 | 90 | 100 | 100 | 100 | 90 | 50 | 100 | 90 | 70 |
| C4 | 1000 | 100 | 100 | 100 | 100 | 100 | 90 | 100 | 100 | 90 |
| C5 | 500 | 90 | 100 | 90 | 70 | 100 | 60 | 90 | 80 | 90 |
| C6 | 1000 | 100 | 100 | 100 | 100 | 100 | 80 | 100 | 90 | 100 |
| C7 | 1000 | 90 | 90 | 100 | 100 | 100 | 60 | 100 | 90 | 80 |
| C8 | 1000 | 100 | 100 | 100 | 100 | 100 | 50 | 100 | 90 | 100 |
| C9 | 1000 | 100 | 90 | 50 | 90 | 80 | 50 | 80 | 70 | 40 |
| C10 | 1000 | 100 | 100 | 100 | 80 | 100 | 20 | 90 | 100 | 70 |
| C11 | 1000 | 100 | 70 | 60 | 70 | 80 | 30 | 70 | 50 | 20 |
| C12 | 500 | 100 | 100 | 100 | 100 | 100 | 40 | 70 | 70 | 70 |
| C13 | 500 | 100 | 100 | 100 | 70 | 100 | 30 | 100 | 100 | 90 |
| C14 | 1000 | 100 | 100 | 100 | 100 | 100 | 60 | 80 | 90 | 70 |
| C15 | 1000 | 40 | 50 | 100 | 20 | 80 | 20 | 70 | 50 | 50 |
| C16 | 1000 | 100 | 90 | 90 | 70 | 100 | 50 | 80 | 80 | 90 |
| C17 | 1000 | 10 | 10 | 20 | 10 | 10 | 0 | 10 | 10 | 10 |
| C18 | 1000 | 100 | 80 | 100 | 80 | 100 | 80 | 100 | 100 | 100 |
| C19 | 500 | 10 | 10 | 0 | 0 | 10 | 10 | 10 | 10 | 10 |
| C20 | 1000 | 40 | 40 | 30 | 60 | 10 | 10 | 20 | 10 | 10 |
| C21 | 500 | 100 | 100 | 100 | 100 | 100 | 70 | 100 | 100 | 70 |
| C22 | 500 | 10 | 20 | 60 | 20 | 60 | 10 | 60 | 30 | 20 |
| C23 | 125 | 20 | 10 | 40 | 10 | 40 | 10 | 60 | 30 | 30 |
| C24 | 1000 | 100 | 80 | 100 | 50 | 90 | 30 | 60 | 70 | 40 |
| C25 | 1000 | 100 | 90 | 80 | 60 | 100 | 60 | 50 | 80 | 90 |
| C26 | 1000 | 100 | 90 | 100 | 60 | 90 | 40 | 60 | 90 | 60 |
| C27 | 500 | 100 | 100 | 100 | 90 | 100 | 90 | 100 | 100 | 100 |

1. A liquid agrochemical composition comprising:
(i) a herbicidally effective amount of a compound of Formula (I) or an agrochemically acceptable salt or zwitterionic species thereof: 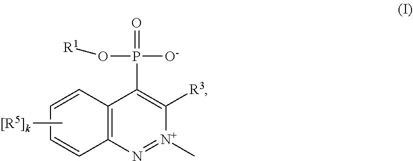
wherein
R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of hydrogen, halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or R¹⁶ and R¹⁷ together with the nitrogen atom to which they are attached form a 4- to 6-membered heterocyclyl ring which optionally comprises one additional heteroatom individually selected from N, O and S;
(ii) at least one anionic surfactant that is an alkyl ether sulfate of Formula
R(OCH₂CH₂)ₙOSO₃⁻,
wherein R is a C₁₀-C₁₆alkyl group and n is an integer of 2-30;
and,
(iii) at least one solvent.

2. The liquid agrochemical composition of claim 1, wherein in the anionic surfactant of (ii), n is an integer of 2-4.

3. The liquid agrochemical composition of claim 1, wherein in the anionic surfactant of (ii), n is an integer of 3.

4. The liquid agrochemical composition of claim 1, which is an emulsion concentrate (EC), and emulsion in water (EW), a microcapsule formulation (CS), a dispersion concentrate (DC), a suspension of particles in an emulsion (SE), a suspension of particles in oil (OD), or a soluble liquid (SL).

5. A compound of Formula (IA) or an agrochemically acceptable salt or zwitterionic species thereof, 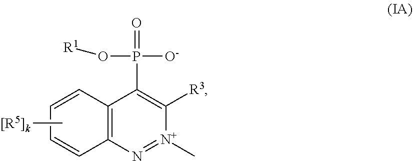
wherein,
R¹ is selected from the group consisting of: C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, (CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of hydrogen, halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or R¹⁶ and R¹⁷ together with the nitrogen atom to which they are attached form a 4- to 6-membered heterocyclyl ring which optionally comprises one additional heteroatom individually selected from N, O and S.

6. A compound of Formula (TB) or an agrochemically acceptable salt or zwitterionic species thereof 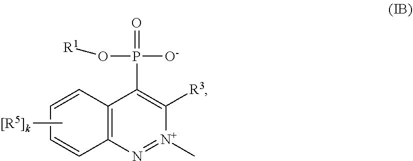
wherein
R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or R¹⁶ and R¹⁷ together with the nitrogen atom to which they are attached form a 4- to 6-membered heterocyclyl ring which optionally comprises one additional heteroatom individually selected from N, O and S.

7. A compound of Formula (IC) or an agrochemically acceptable salt or zwitterionic species thereof 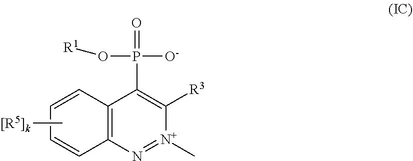
wherein,
R¹ is selected from the group consisting of: C₁-C₆alkyl, C₂-C₆alkenyl, C₂-C₆alkynyl, C₃-C₆cycloalkyl, —C₁-C₃alkylC₃-C₆cycloalkyl, C₁-C₆haloalkyl, —C₁-C₃alkylC₁-C₆haloalkoxy, —(CR⁸₂)_{q}C(O)R¹⁵, —(CR⁸₂)_{q}C(O)OR¹⁰, —(CR⁸₂)_{q}C(O)NR¹⁶R¹⁷, —(CR⁸₂)_{q}NH₂, —(CR⁸₂)_{q}NHR⁷, —(CR⁸₂)_{q}N(R⁷)₂, —(CR⁸₂)_{q}OH, —(CR⁸₂)_{q}OR⁷, —(CR⁸₂)_{q}SR¹⁵, —(CR⁸₂)_{q}S(O)R¹⁵, —(CR⁸₂)_{q}S(O)₂R¹⁵, —(CR⁸₂)_{q}S(O)₂NR¹⁶NR¹⁷, C₅- or C₆-heterocyclyl, —C₁-C₃alkylC₅-C₆heterocyclyl, C₅- or C₆-heteroaryl, —C₁-C₃alkylC₅-C₆heteroaryl, phenyl or —C₁-C₃alkylphenyl, wherein said heteroaryl moiety comprises 1, 2, 3 or 4 heteroatoms individually selected from N, O and S, said heterocyclyl moiety comprises 1, 2 or 3 heteroatoms individually selected from N, O and S, and said phenyl, heteroaryl and heterocyclyl moieties are optionally substituted by 1 or 2 R² substituents;
q is an integer of 0, 1, 2, or 3;
each R² is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, N—C₃-C₆cycloalkylamino-, and —C(R⁶)═NOR⁶;
R³ is selected from the group consisting of halogen, cyano, nitro, —S(O)ᵣR⁴, C₁-C₆alkyl, C₁-C₆haloalkyl, C₁-C₆haloalkoxy, C₁-C₆alkoxy, C₃-C₆cycloalkyl, —N(R⁶)₂, phenyl, a 5- or 6-membered heteroaryl comprising 1, 2, 3 or 4 heteroatoms individually selected from N, O and S, and a 4- to 6-membered heterocyclyl comprising 1, 2 or 3 heteroatoms individually selected from N, O and S, and wherein said phenyl, heteroaryl or heterocyclyl moieties are optionally substituted by 1 or 2 R² substituents;
R⁴ is selected from the group consisting of C₁-C₆alkyl and phenyl, and wherein said phenyl is optionally substituted by 1, 2 or 3 R² substituents;
r is an integer of 0, 1, or 2;
k is an integer of 0, 1, 2, 3, or 4;
when k is 1 or 2, each R⁵ is independently selected from the group consisting of halogen, nitro, cyano, —NH₂, —NHR⁹, —N(R⁹)₂, —OH, —OR⁹, —S(O)ᵣR¹⁵, —NR⁶S(O)₂R¹⁵, —C(O)OR¹⁰, —C(O)R¹⁵, —C(O)NR¹⁶R¹⁷, —S(O)₂NR¹⁶R¹⁷, C₁-C₆alkyl, C₁-C₆haloalkyl, C₃-C₆cycloalkyl, C₃-C₆halocycloalkyl, C₃-C₆cycloalkoxy, C₂-C₆alkenyl, C₂-C₆haloalkenyl, C₂-C₆alkynyl, C₁-C₃alkoxyC₁-C₃alkyl-, hydroxyC₁-C₆alkyl-, C₁-C₃alkoxyC₁-C₃alkoxy-, C₁-C₆haloalkoxy, C₁-C₃haloalkoxyC₁-C₃alkyl-, C₃-C₆alkenyloxy, C₃-C₆alkynyloxy, —N—C₃-C₆cycloalkylamino, —C(R⁶)═NOR⁶, phenyl, a 3- to 6-membered heterocyclyl, which comprises 1 or 2 heteroatoms individually selected from N and O, and a 5- or 6-membered heteroaryl, which comprises 1, 2, 3 or 4 heteroatoms individually selected from N, O and S, and wherein said phenyl, heterocyclyl or heteroaryl are optionally substituted by 1, 2 or 3 R¹¹ substituents;
when k is 3 or 4, each R⁵ is independently selected from the group consisting of halogen, —NH₂, —NHR⁹, —N(R⁹)₂, —OH, —OR⁹, —C(O)NR¹⁶R¹⁷, —S(O)₂NR¹⁶R¹⁷, C₁-C₆alkyl and C₁-C₆haloalkyl;
each R⁶ is independently selected from hydrogen and C₁-C₆alkyl;
each R⁷ is independently hydrogen or C₁-C₆alkyl;
each R⁸ is independently hydrogen or C₁-C₆alkyl,
each R⁹ is independently selected from the group consisting of C₁-C₆alkyl, —S(O)₂R¹⁵, —C(O)R¹⁵, —C(O)OR¹⁵ and —C(O)NR¹⁶R¹⁷;
R¹⁰ is selected from the group consisting of hydrogen, C₁-C₆alkyl, phenyl and benzyl, and wherein said phenyl or benzyl are optionally substituted by 1, 2 or 3 R¹¹ substituents;
each R¹¹ is independently selected from the group consisting of halogen, cyano, hydroxyl, —N(R⁶)₂, C₁-C₄alkyl, C₁-C₄alkoxy, C₁-C₄haloalkyl and C₁-C₄haloalkoxy;
R¹⁵ is selected from the group consisting of C₁-C₆alkyl and phenyl, and wherein said phenyl is optionally substituted by 1, 2 or 3 R¹¹ substituents;
R¹⁶ and R¹⁷ are independently selected from the group consisting of hydrogen and C₁-C₆alkyl; or R¹⁶ and R¹⁷ together with the nitrogen atom to which they are attached form a 4- to 6-membered heterocyclyl ring which optionally comprises one additional heteroatom individually selected from N, O and S;
with the proviso that
(i) when R³ is hydrogen, and k is 0, R¹ is not methyl, ethyl, isopropyl, n-butyl, 2, 2,2 trichloroethyl, or cylcohexyl;
(ii) when R³ is hydrogen, k is 1, and R⁵ is 5-chloro, 5-methyl, 5-methoxy, 6-chloro, 6-fluoro, 6-trifluoromethyl, 6-cyano, 6-nitro, 6-methoxy, 6-ethoxy, 6-isopropoxy, 6-methylsulfonyl, 6-methylthio, 7-trifluoromethyl, 7-methoxy, 7-nitro, 8-fluoro, 8-chloro, 8-trifluoromethyl, 8-nitro, 8-methoxy, 8-ethoxy, 8-isopropoxy, 8-methylsulfonyl, or 8-methylthio, then R¹ is not methyl; and
(iii) when R¹ is methyl, R³ is hydrogen, k is 2 and the two R⁵ substituents are either at positions 6 and 7, or positions 7 and 8 of the cinnolinium ring, then the two R⁵ substituents are not both methyl.

8. The liquid agrochemical composition of claim 1, wherein the compound of Formula (I) is: the compound of Formula (IA) as defined in claim 5, the compound of Formula (IB) as defined in claim 6, or the compound of Formula (IC) as defined in claim 7.

9. Use of a compound of Formula (IA) as defined in claim 5, as a herbicide.

10. A method of controlling or preventing undesirable plant growth, wherein a herbicidally effective amount of a compound of Formula (IA) as defined in claim 5 as active ingredient, is applied to the plants, to parts thereof or the locus thereof.

11. A method of controlling or preventing undesirable plant growth, wherein a liquid agrochemical composition as defined in claim 1 is applied to the plants, to parts thereof or the locus thereof.

12. Use of a compound of Formula (IB) as defined in claim 6, as a herbicide.

13. Use of a compound of Formula (IC) as defined in claim 7, as a herbicide.

14. A method of controlling or preventing undesirable plant growth, wherein a herbicidally effective amount of a compound of Formula (IB) as defined in claim 6 as active ingredient, is applied to the plants, to parts thereof or the locus thereof.

15. A method of controlling or preventing undesirable plant growth, wherein a herbicidally effective amount of a compound of Formula (IC) as defined in claim 7 as active ingredient, is applied to the plants, to parts thereof or the locus thereof.
